(19) United States
(12) Patent Application Publication
(10) Pub. No.: US 2003/0154094 A1
(43) Pub. Date: Aug. 14, 2003

(54) Interactive warranty product comparison system and method

(76) Inventors: Andrew Peter Bredemeier, Yellow Jacket, CO (US); Darrin Jay Steed, Aztec, NM (US); Michael Joseph Hersh, Marietta, GA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/330,549

(22) Filed: Dec. 30, 2002

Related U.S. Application Data
(60) Provisional application No. 60/342,743, filed on Dec. 28, 2001.

(51) Int. Cl. G06F 17/60

(52) U.S. Cl. 705/1

(57) ABSTRACT

A method and system for interactively comparing extended warranty products of various providers. Initially, the system receives and saves extended warranty product information relating to at least two competing extended warranty products. Upon receipt of a user request to compare extended warranty products for a particular application, the system receives test case product data. The system then analyzes the received test case product data and retrieves, from the saved extended warranty product information, the particular extended warranty cost information that corresponds to the received test case product data for each of the at least two competing extended warranty products. The system then identifies the extended warranty product having the lower cost for the particular test case application. This information is then displayed to the user.

### CROSS-REFERENCE TO RELATED APPLICATIONS

The present application claims the benefit of U.S. Provisional Patent Application No. 60/342,743 filed Dec. 28, 2001, the entirety of which is incorporated by reference herein.

### BACKGROUND OF THE INVENTION

The present invention relates generally to systems and methods for comparing information from different sources. More particularly, the present invention relates to a comprehensive system for comparing warranty products offered by different providers.

For many expensive consumer products such as a motor vehicle, a household appliance or an electronic product, such as a television or a computer, it is often desirable to purchase a maintenance service contract to help defray the costs of repairs and maintenance services relating to the consumer product beyond the expiration of a manufacturer's standard warranty term or period. These service contracts are sometimes referred to as “extended warranties.”

These service contracts or extended warranties are similar to insurance contracts. A consumer will typically purchase “coverage” against certain types of occurrences. For example, under a typical motor vehicle service contract or extended warranty, the consumer's service contract provides coverage for mechanical breakdowns or repairs that may be required to an engine, a fuel system, an electrical system, a cooling system, a transmission, and an electronic system of a motor vehicle after the expiration of the manufacturer's warranty. The consumer must pay periodic premiums to the motor vehicle service contract provider in order to maintain the service contract in effect. If the consumer experiences a problem with the motor vehicle covered by the service contract, the consumer can take the motor vehicle to a repair shop and have the repair shop diagnose the problem. The repair shop may then contact the claims department of the motor vehicle service contract provider to determine whether the problem with the vehicle falls within the scope of coverage under the service contract. If so, the repair shop can obtain authorization from the motor vehicle service contract provider to perform the repair and can submit the invoice for the costs of the performed repair as a “claim” to the service contract provider for payment by the service contract provider. The service contract provider typically pays for the costs of the repair performed by the repair shop minus an amount equal to a “deductible” from a covered claim under the service contract, which “deductible” the consumer is responsible for paying. The service contract provider makes profits on the service contract if the consumer's premium payments under the service contract, plus interest income earned on premium reserves exceed the repair and administrative costs incurred by the service contract provider. In contrast, if a motor vehicle requires extensive repairs over the life of the service contract, the service contract provider's profits will be less. In determining which extended warranty or service contract products provide the best opportunity for generating profits for the motor vehicle dealership (assuming the motor vehicle dealership will service the contract), motor vehicle dealerships are often presented with a wide variety of warranty product offerings. In conducting extended warranty product comparisons, the motor vehicle dealerships must take many factors into consideration, including a determination of how the various extended warranty products compete in relation to the specific motor vehicle dealership's historical motor vehicle sales profile as well as across a range of extended warranty (or service) coverages to be offered to customers in connection with the various extended warranty products.

Conventionally, extended warranty products are presented to motor vehicle dealerships using a theoretical ‘best cars’ model. That is, the warranty rates for the competing warranty products are generated and presented for a collection of motor vehicles designed to provide a generalized cross-section of a particular market. Unfortunately, this collection of motor vehicles often does not accurately reflect the sales profile of a given motor vehicle dealership. Consequently, upon servicing motor vehicles under the motor vehicle dealership's service contracts, the motor vehicle dealership may come to determine that the expected profitability is not being realized due to differences in the motor vehicle dealership's specific sales profile from the ‘best cars’ presented to it. Similarly, sellers of products other than motor vehicles which may be covered by extended warranties or service contracts, as mentioned above, may also realize less profits than expected due to a failure to consider extended warranty or service contracts designed more specifically to the seller's product mix.

Therefore, there is a need in the area of extended warranty or service contract products and services for a system and method for providing detailed extended warranty product comparisons relating to specific collections of products covered under extended warranty or service contract products.

### BRIEF SUMMARY OF THE INVENTION

The present invention overcomes the problems noted above, and realizes additional advantages, by providing for a method and system for enabling interactive comparison of a plurality of extended warranty products of a plurality of providers and plurality of specific makes and models sold by a given dealership. The system of the present invention includes a computer readable medium including a software application for enabling interactive comparison of a plurality of extended warranty products of a plurality of providers. The software application comprises one or more instructions for receiving extended warranty product information for at least two extended warranty products, the extended warranty product information including at least extended warranty product rate information for a plurality products to be covered by the extended warranty products; one or more instructions for saving the extended warranty product information; one or more instructions for receiving a request to compare the at least two extended warranty products; one or more instructions for receiving test case product data relating to at least one product to be covered by an extended warranty product; one or more instructions for receiving a selection of a first extended warranty product and a second extended warranty product from the at least two extended warranty products; one or more instructions for retrieving from the received extended warranty product information associated with the first extended warranty product and the second extended warranty product, a first extended warranty product rate and a second extended warranty product rate for the at least one product to be covered by an extended warranty product; and one or more instructions for displaying the first extended warranty product rate and the second extended warranty product rate.

In addition to providing for the interactive comparison of extended warranty products for specific test case product data, the present system also preferably provides various other options to users such as the ability to create and manage product collection files and a variety of extended warranty product coverage types including specific collections of products to be covered by extended warranty products and coverages. Further, the system preferably provides a product identification number look-up utility which enables users to search for and test selected products to be covered by extended warranty products.

An additional embodiment of the present invention incorporates a utility for enabling users to further identify auto warranty reinsurance costs and related information for a variety of extended warranty products. In particular, warranty premium information and relative vehicle mix information are utilized to generate various types of reinsurance analysis information such as the amount of potential annual premiums received by the reinsurance provider for a given mix of warranty products, and profit per contract for a combined group of warranty products.

By providing the above-described features in a comprehensive, user-friendly manner, the system optimizes the efficiency of the entire extended warranty cost and profitability comparison process and enables sellers such as motor vehicle dealerships to more accurately determine the most profitable collection of extended warranty products to purchase for sale to customers.

### BRIEF DESCRIPTION OF THE DRAWINGS

The present invention can be understood more completely by reading the following Detailed Description of the Invention, in conjunction with the accompanying drawings, in which:

FIG. 1 is a flow chart describing the steps performed in one embodiment of a method for comparing two different extended warranty products;

FIG. 2 illustrates a first embodiment of a graphical user interface for facilitating the method and system of the present invention;

FIG. 3 is a flow chart describing the steps performed in a second embodiment of a method for comparing two different extended warranty products;

FIG. 4 is a flow chart describing the steps performed in one embodiment of a method for displaying rate calculation results;

FIG. 5 illustrates one embodiment of a graphical user interface for displaying result information;

FIG. 6 illustrates one embodiment of a ‘Details’ tab section;

FIG. 7 illustrates one embodiment of a ‘Rpt Table 5’ tab section;

FIG. 8 illustrates one embodiment of a ‘Reports’ tab section;

FIG. 9 illustrates one embodiment of a graphical user interface for enabling users to view and modify data files;

FIG. 10 is a flow chart describing the steps performed in one embodiment of a method for building or appending product feed files;

FIG. 11 illustrates one embodiment of a coverage mix file display section of the graphical user interface of FIG. 9;

FIG. 12 illustrates one embodiment of a product/coverage file display section of the graphical user interface of FIG. 9;

FIG. 13 illustrates one embodiment of a rate one saves display section of the graphical user interface of FIG. 9;

FIG. 14 is a flow chart describing the steps performed in one embodiment of a method for generating reinsurance information;

FIG. 15 illustrates one embodiment of a first reinsurance analysis tool input/summary display section;

FIG. 16 illustrates one embodiment of a second reinsurance analysis tool input/summary display section;

FIG. 17 illustrates one embodiment of a reinsurance analysis tool results display section as generated for a sample reinsurance provider; and

FIG. 18 illustrates one embodiment of a reinsurance analysis tool results display section as generated for an underwriting company.

### DETAILED DESCRIPTION OF THE INVENTION

The system and method of the present invention described below are preferably implemented by an interactive computer software application incorporated within a computer-readable medium such as a hard disk drive, an optical medium such as a compact disk, or the like. Further, the computer-readable medium may be available to a user either locally on a user's computer or remotely over a computer network, such as a local area network (LAN), a wide area network (WAN), the Internet, or any other suitable computer network. The inventive interactive computer software application is designed to receive information related to multiple extended warranty products as well as test case information interactively provided by the user. The software application then operates to analyze the received test case information compared against the extended warranty product information and, further, operates to present several output options to the user in a convenient, easily understood and useful manner. In a preferred embodiment, the interactive software application is written using Microsoft Access® database software, available from Microsoft Corporation, although any suitable programming language and interface should be understood to be within the scope of the present invention.

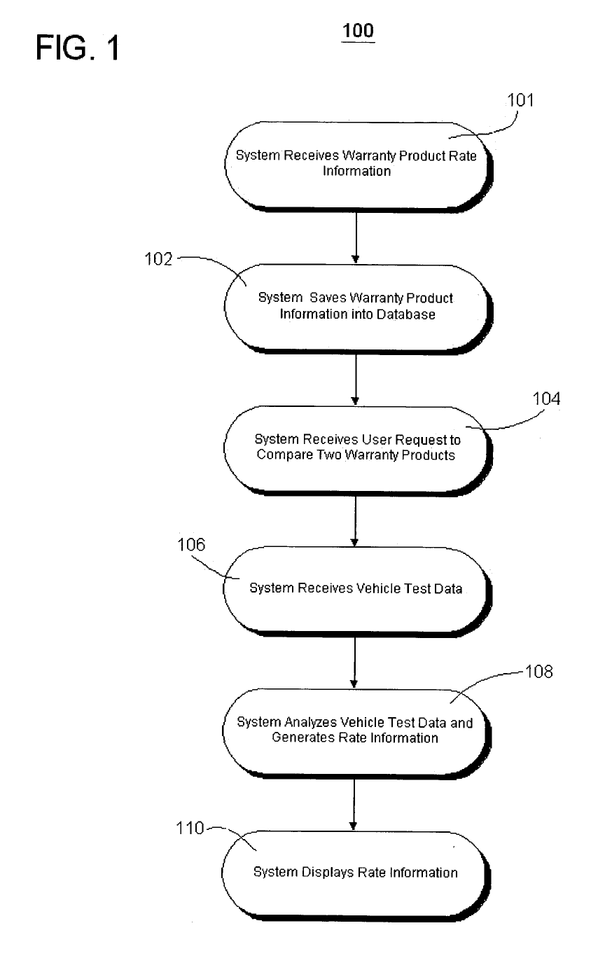

Referring to the Figures and, in particular, to FIG. 1, there is shown a flow chart describing the steps performed in a method 100 for comparing two different extended warranty products in accordance with one embodiment of the present invention. In step 101, an extended warranty product comparison system (hereinafter referred to as “the system”) receives extended warranty product rate information relating to at least two extended warranty products. In step 102, the system saves the extended warranty product rate information into at least one database associated with the system. Preferably, the system uploads the extended warranty product information into a resident database from a user designated file location, however, any suitable manner of information importation/retrieval may be utilized.

Upon receiving extended warranty product rate information, the system, in step 104, receives a user request to compare two of the extended warranty products with test case data relating to at least one particular warranted product, for example, a motor vehicle. It should be understood, however, that the invention is not limited to use in connection with motor vehicles, but is also applicable to other types of products for which service providers offer extended warranties or service contacts. The example of motor vehicles will be used from this point forward to describe the present invention for purposes of illustration.

In response to the user request of step 104, in step 106, the system receives motor vehicle data related to the at least one motor vehicle for which the motor vehicle extended warranty products are to be compared. Next, in step 108, the system analyzes the received motor vehicle data and generates at least extended warranty product rate information for each motor vehicle. In step 110, the generated rate information is displayed to the user for review.

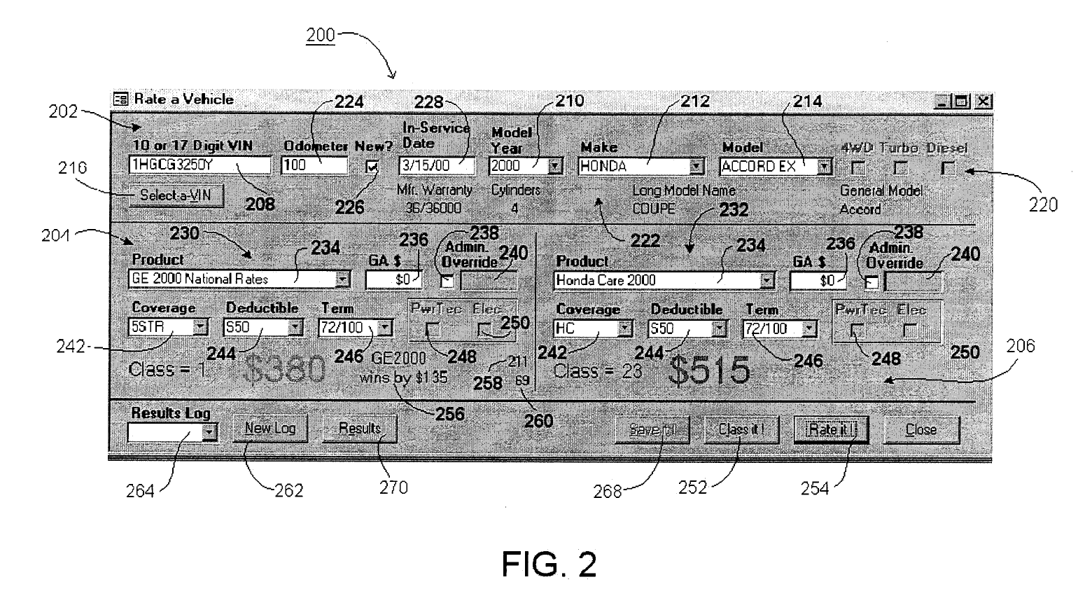

Referring now to FIG. 2, there is shown a first embodiment of a graphical user interface (GUI) 200 for facilitating the method and system of the present invention. As is understood in the art of software design, a GUI typically provides a system user with a plurality of data entry and manipulation capabilities associated with the system. Accordingly, although a particular layout is described below, any GUI suitable for enabling a user to perform the above described tasks may be utilized.

Relating to the first embodiment, the GUI 200 enables a system user to compare a plurality of extended warranty product rates for a single particular product, for example, a motor vehicle. As is understood in the art, warranty product rates for automotive service contracts vary greatly depending upon a large number of individual variables, including the following: Mile/Term, Term/Coverage, Make & Model or VIN#, Mileage, Year Built, Deductible, Coverage Type (Bumper to Bumper, etc.), Dealer Pack/Dealer Commission, Reinsurance Fee, Engine Type (Turbo, Diesel), number of cylinders, drivetrain (4wd, 2wd), Options (Powertech, electronics, etc.). As set forth in detail below, information is initially received relating to the various warranty products available, a specific dealer's inventory and the pack of products applied to the dealer. Then, specific information relating to each vehicle in the inventory is used to identify the applicable rate for each product. The combination of information is then used to generate sever; types of reports and a final determination of which provider offers the best product for the specific dealer.

Returning now to FIG. 2, GUI 200 is preferably broken down into three distinct information sections: a motor vehicle selection section 202 for receiving motor vehicle selection information; an extended warranty products identification section 204 for receiving identification information related to the two extended warranty product rates to be compared; and a results section 206 for displaying the results of the extended warranty product comparison for the selected motor vehicle.

Relating specifically to the motor vehicle selection section 202, there are preferably provided at least two different manners for indicating the type of product (e.g., motor vehicle) for which extended warranty product rates are to be compared. In a first manner, a user enters a 10-digit or a 17-digit product identification number (e.g., a vehicle identification number or a VIN for a motor vehicle to be covered by an extended warranty product) into a VIN field 208. This VIN field 208 allows the user to submit either a 10-digit or a 17-digit VIN entry (the last 6 digits of the VIN do not contain data used in identifying motor vehicles and their characteristics). It should be understood, however, using the full 17-digit VIN is recommended where reporting requires each motor vehicle to be listed individually. If just a 10-digit VIN is used, similar motor vehicles may be grouped or even eliminated through optimizing.

Once a VIN is entered by the user, and the user moves to another field on the GUI 200, the system decodes the submitted VIN and retrieves the corresponding motor vehicle information, if any, from a comprehensive motor vehicle database associated with the system. One such database is provided by R. L. Polk & Co. of Southfield, Mich. Upon finding a match, the motor vehicle information is displayed in a series of fields including a motor vehicle model year field 210, a motor vehicle make field 212, and a motor vehicle model field 214. If a match is not found, an error box will appear, providing information about a problem occurring and asking the user to supply a proper VIN. In one embodiment, errors in matching user supplied VIN's will occur if the following criteria are not met: 1) the length of the VIN is not 10 or 17 digits; 2) the motor vehicle make cannot be identified, based upon the first 3 digits of the VIN; 3) the model year cannot be determined, based upon the 10th digit of the VIN; and 4) the VIN is not found in the database of motor vehicle information associated with the system.

Users need not know the VIN of a motor vehicle in order to compare motor vehicle warranty products for a desired motor vehicle. In accordance with the second manner for indicating the type of motor vehicle for which motor vehicle warranty rates are to be compared, users may select the model year, the make, and the model of a particular motor vehicle using a plurality of drop-down menus associated with the year/make/model fields 210-214 described above. In a manner well known in the art, the model year/make/model drop down menus 210-214 are preferably of the ‘drill down’ variety. That is, upon selection of a particular value in any of the menus, only selections corresponding to the selected value are displayed in the remaining menus. For example, upon selection of a 1999 model year in the model year field 210, only motor vehicle makes and models built in 1999 are displayed in the make field 212 and the model field 214, respectively. Further, upon selection of a particular motor vehicle make in the make field 212, only models manufactured by the selected maker are displayed in the model field 214.

Once a motor vehicle year, make and model have been selected, the user clicks on a ‘Select-a-VIN’ button 216. Upon this selection, the system retrieves VIN's from the Polk database associated with the selected motor vehicle model year, make and model and displays a drop-down menu (not shown) including a listing of all corresponding VIN's. The user may scroll through the listing and select the motor vehicle with the desired characteristics displayed matching the user's needs.

Additional motor vehicle information corresponding to the selected VIN is displayed in area 220. The additional information includes particular VIN characteristics defined in the VIN, such as ‘4wd’, ‘Turbo’ and ‘Diesel’. If a particular characteristic is not available for the selected motor vehicle, the corresponding field is gray, and not available for selection. However, if the characteristic is available as an option, the field is available for the user to select, if applicable. If the characteristic is not optional, it will be checked and locked so the user may not deselect it. Further description of the motor vehicle also appears below the drop-down menus in area 222 and includes a manufacturer's warranty description, a cylinders description, a long model name description, and a general model description. In one embodiment, the GUI 200 also includes fields 224, 226, and 228 for enabling the user to indicate a mileage of the particular motor vehicle in field 224, whether the particular motor vehicle was purchased new in field 226, and, if so, an in-service date of the motor vehicle in field 228, respectively.

Relating now to the motor vehicle extended warranty products selection section 204, various fields are included for enabling the user to identify the two extended warranty products to be compared. In particular, a pair of corresponding sections, a section 230 and a section 232, enable the user to submit a first extended warranty product and a second extended warranty product, respectively. Each one of the section 230 and the section 232 includes a product drop-down menu 234, which includes a listing of all extended warranty products included for comparison by the system. A user may scroll down the extended warranty product listing and select the first extended warranty product to compare. A rating adjustment field 236 enables the user to enter a dollar amount rate adjustment for the selected extended warranty product. An administrative override check-box 238 enables the user to enter a specific administrative cost associated with the selected extended warranty product in a field 240. This amount replaces a default administrative cost initially associated with the selected extended warranty product. In one embodiment, once the check-box 238 is checked, a default value of $75 appears in the field 240. This amount overrides a value associated with the selected extended warranty product, and replaces it with the amount entered in field 240.

A coverage drop-down menu 242 includes a listing of all available coverage levels for the extended warranty product selected in the product drop-down menu 234. A deductible drop-down menu 244 includes a listing of a plurality of available deductibles for the selected extended warranty product. A term drop-down menu 246 includes a listing of all available terms for the selected extended warranty product. An optional PwrTec check box 248 and an optional Elec check box 250 enable the user to select optional coverages of powertech and electronics, for example, which may result in a surcharge being added to the extended warranty product rate for a motor vehicle extended warranty product. For motor vehicle warranty products not including these options, the optional check boxes 248 and 250 are not available for selection.

According to one embodiment of the present invention, the majority of information in the section 230 and the section 232 are mapped to each other. That is, upon selection of a pair of extended warranty products for comparison, information entered in the various fields 242-250, described above, for either the first extended warranty product or the second extended warranty product, will result in an automatic retrieval of corresponding information for the other extended warranty product. For example, if a $50 deductible is selected for the extended warranty product selected in the deductible drop-down menu 244 of the section 230, a $50 deductible, if available, is retrieved and selected in the deductible drop-down menu 244 of the section 232. In circumstances where corresponding features are not available between the two extended warranty products to be compared, a warning message is generated and displayed to the user.

Once all of the required extended warranty product information has been submitted and/or retrieved in the section 202 and the section 204, the system enables to user the conduct the comparison and view the results in section 206. If any required information has not been submitted, an error message is generated noting the deficiency to the user. Next, before the extended warranty product rates may be calculated for the competing extended warranty products, the extended warranty products must be classified. For example, a class of coverage for a specific motor vehicle related to the selected motor vehicle extended warranty product is retrieved. In a preferred embodiment, this classification takes place automatically upon sequential entry of all necessary motor vehicle extended warranty product information. However, if the extended warranty product information was entered non-sequentially, the user may request classification of the extended warranty products by selecting a ‘Class it!’ button 252.

Once the product to be covered by an extended warranty product, such as a motor vehicle, has been classified for each of the selected extended warranty products, the user can click on a ‘Rate it!’ button 254 to retrieve the rate information for each of the selected extended warranty products. In a preferred embodiment, upon retrieving the rate information, the system determines which rate is lower and displays the lower rate in a green color, while displaying the higher rate in a red color. Further, the system displays a winning rate message 256 indicating which rate is lower and by what margin. If a tie results, both rates appear in black text, and no message appears. In the preferred embodiment, a first value 258 and a second value 260 appear next to a dividing line between the rates for the two extended warranty products. The first value 258 is the calculated ‘Premium’ associated with the rate. The second value 260 is an ‘Admin. Fee’. As is known in the art of extended warranty products, the first value 258 and the second value 260, combined with applicable commissions, make up a total calculated rate.

In a preferred embodiment of the present system, users are able to save the results of their comparisons to a Results Log for later review and/or printing. Preferably, the generated results can either be set up in a ‘New’ log file, or appended to an existing file. Following a selection of two extended warranty products to compare, the user may select a ‘New Log’ button 262. In response, the system displays a message box, verifying whether the user wishes to establish a new record. If the user affirms the creation of a new record, a log number is assigned to a results set. Preferably, this log number is sequentially assigned based upon a last previously saved results log, however, any log numbering convention may be utilized. For assignment of the log number, the system displays the log number in a ‘Results Log’ box 264. Preferably, the ‘Results Log’ box 264 also forms a drop-down menu including a listing of all previously saved results logs along with the extended warranty product codes selected for comparison. By selecting a previous log, the extended warranty products to be compared are reset to the extended warranty products initially saved in the selected results log. Any new motor vehicles or modified extended warranty product features will be saved as part of the selected results set.

Once the user has established a new results log or selected a previously established results log to append, the user rates the extended warranty product in the manner set forth above. Once rates are retrieved and displayed, a ‘Comments’ box (not shown) appears in which the user may enter comments related to the extended warranty product comparison. Any comments entered here will be written to the results log as each record is saved. By selecting the ‘Save It!’ button 268, the user records each rated extended warranty products to the selected results log. All of the results that are part of the current results log can be viewed and manipulated by selecting a ‘Results’ button 270. As will be described in additional detail below, retrieval and manipulation of the results enables users to better determine the profitability of the various extended warranty products.

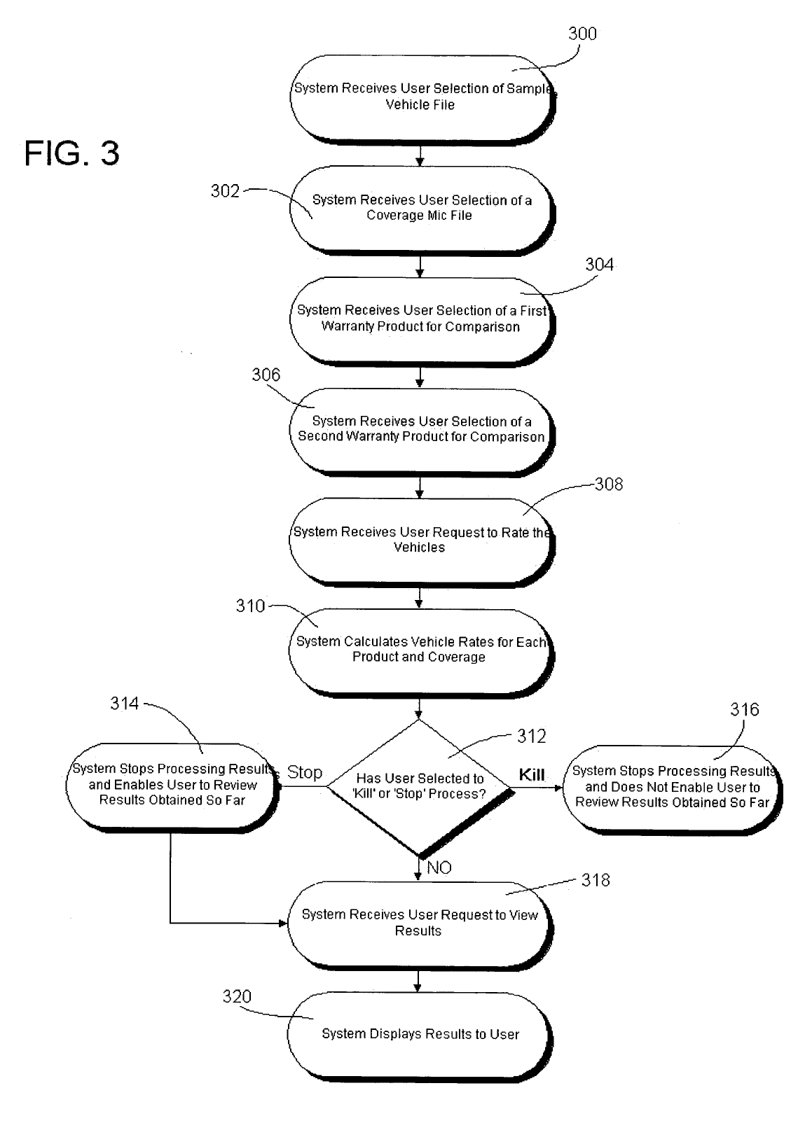

Referring now to FIG. 3, there is shown a flow chart describing the steps performed in a second method for comparing extended warranty product rates for a large number of test products, such as motor vehicles, in accordance with the present invention. In a practical implementation of the present invention, it is desirable to compare large quantities of test data related to specific types and numbers of motor vehicles. In this manner, a current, or a recent inventory of a motor vehicle dealership can be reviewed with respect to several extended warranty products for the purposes of determining which extended warranty products are most profitable to the motor vehicle dealership. Accordingly, the present invention provides users with the ability to feed large quantities of data into the system for simultaneous comparison against selected extended warranty products.

In step 300, the system receives a user selection of a sample product file, such as a motor vehicle file, to utilize in the extended warranty product comparison. Additional details of the creation and population of sample motor vehicle files will be discussed in detail below, however, at this point it should be understood that each sample motor vehicle file includes at least the VIN's for a selected group of motor vehicles. In step 302, the system receives a user selection of a coverage mix file generally describing a type of coverage to be applied to the sample motor vehicle file. Preferably, the selection of the sample motor vehicle file and coverage mix file are accomplished by using drop-down menus including listings of all available coverage mix files. In a preferred embodiment, the system further enables the user to optionally select a previously established Actual Vehicle/Coverage file combining a sample motor vehicle file and a coverage file. If an Actual Vehicle/Coverage file is selected, the user is prevented from selecting particular sample motor vehicle file and coverage mix files in the manner described above.

Once the motor vehicles and coverage mixes have been selected, the system, in step 304, receives a user selection of a first extended warranty product for comparison. Preferably, the first extended warranty product for comparison is defaulted to a particular extended warranty product, however, this is not necessary. In step 306, the system receives a user selection of a second extended warranty product for comparison. Preferably, the extended warranty products may be selected by using a pair of drop-down menus including listings of all available extended warranty products. In a preferred embodiment, the user may also modify the extended warranty product commission and administrative fees applicable to either one or both of the selected extended warranty products.

Once all of the necessary file selections have been made, the system, in step 308, receives a user request to rate the motor vehicles for the selected coverage levels of both extended warranty products. In response to this request, the system, in step 310, calculates the rates for each of the motor vehicles and for the selected coverage levels. Preferably, the system displays a rating score card to the user during the rate calculation. The rating score card provides an ongoing status report of the rating process. As records are processed, the results are written to a database. In one embodiment, the extended warranty products selected for comparison appear as column headers, under which the number of ‘Wins’ for each extended warranty product is tallied. Further, five primary ‘Error’ types can occur during the rating process including VIN recognition errors, coverage level errors, etc. The number of errors falling under each of these types is also preferably displayed on the rating score card. As each record is being processed, the motor vehicle description with the coverage information being applied is also preferably displayed. Above this, a record counter and a timer are displayed to track the progress of the rating process.

In step 312, the system determines whether the user has requested that the rate calculation process be ‘stopped’ or ‘killed’. If the user has elected to ‘stop’ the processing, the system, in step 314, stops processing the data and enables the user to review the results obtained so far. However, if the system determines that the user has elected to ‘kill’ the processing, the system, in step 316, stops processing the data and does not enable the user to review the results obtained up to that point.

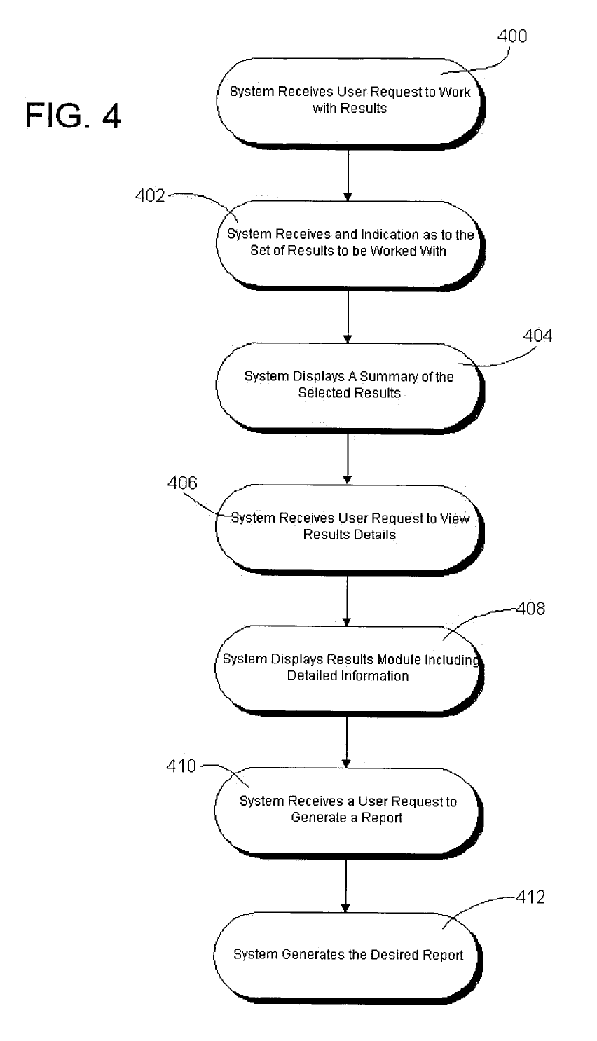

Once the rates have been calculated for the selected combination of data, the system, in step 318, receives a user request to view the results of the rating process. In response, the system, in step 320, displays the results to the user for review and/or printing. FIG. 4, set forth and described in additional detail below, further describes one embodiment for displaying rating results to system users.

Referring now to FIG. 4, there is shown a flow chart describing one embodiment of a method for displaying rate calculation results in accordance with the present invention. Upon completion of at least one extended warranty product comparison conducted in accordance with the manner set forth above, a set of results of the comparison can be selected and used for resolving errors and building reports. In step 400, the system receives a user request to work with a previously generated comparison results set. In step 402, the system receives an indication from the user as to what results set is to be displayed for review.

In a preferred embodiment, the selection of a particular results set may be completed in at least two different ways. First, a particular results set may be referenced by a particular file name under which the results set was saved during the ‘Save it!” operation described above. In a second manner, the user may simply scroll through a listing of all available results sets until the user finds the one results set the user is looking for.

Once the user has selected the particular results set the user would like to review and work with, the system, in step 404, displays a summary of the selected results for initial user review. Preferably, the summary of the selected results includes at least information relating to the names of the two competing extended warranty products, the number of products for which rates were compared and an indication as to the number of potential policies on which each extended warranty product scored lower or ‘won’. Of course, it should be understood that a variety of different summary results sets may be displayed so as to provide the user with sufficient preliminary information to be useful.

In step 406, the system receives a user request to view the details for the selected results set. Correspondingly, in step 408, the system displays a results module including all of the detailed product comparison and test data information. In step 410, the system receives a user request to generate a report corresponding to the selected results set. In response to this request, the system, in step 412, generates the desired report.

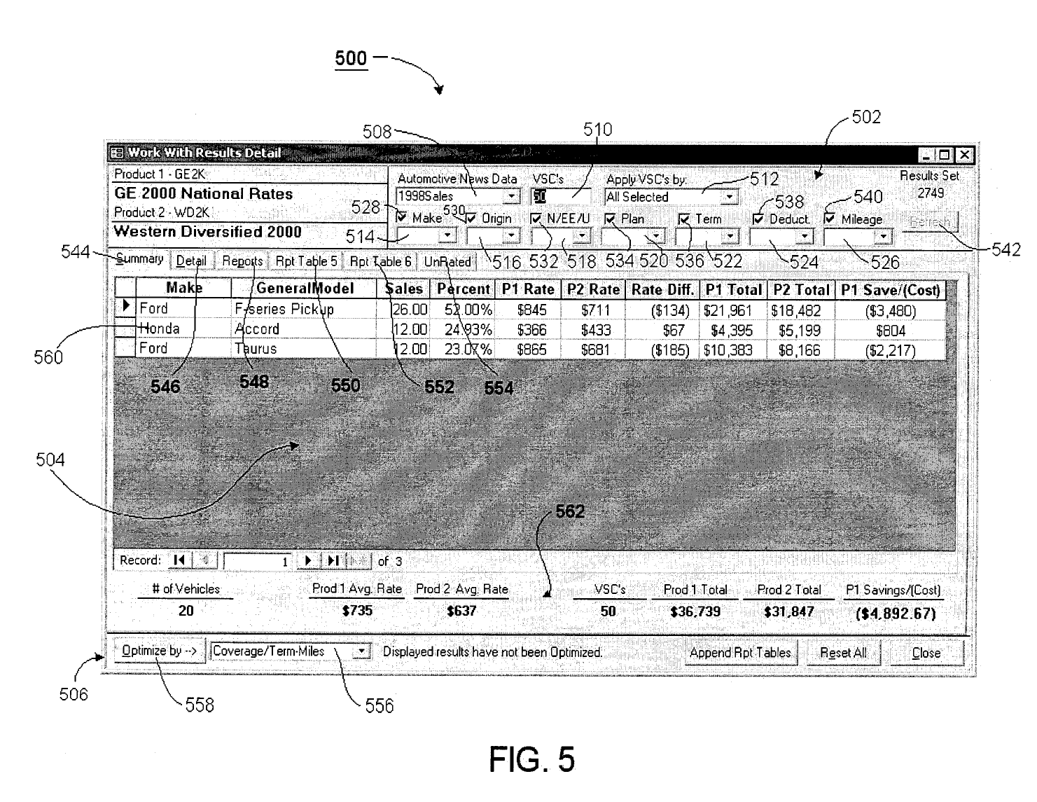

Referring now to FIG. 5, there is shown one preferred embodiment of a GUI 500 for displaying a results set in accordance with the present invention. The GUI 500 is the primary location where the results of the rating data are viewed and sorted, and where reports are built and produced. In particular, there are three general sections within the panel used to accomplish these tasks. A top portion 502 is a data selector section and includes general information as well as interactive elements that enable the user to sort and display the selected results set in a variety of manners. A center portion 504 is a data viewer and reporting section and includes a plurality of user-selectable tabs 544-554 each of which will be described in additional detail below. A bottom section 506 is an optimizing section and includes an interactive element for enabling the user to optimize the results data in a plurality of predetermined ways.

Referring specifically now to the top portion 502, a plurality of dropdown menu selectors are used for sorting and displaying information within a ‘Summary’ tab section 544 and a ‘Detail’ tab section 546 described below. A dropdown menu 508 enables the user to select a particular annual report published by Automotive News. Upon selection of the particular annual report, a plurality of national sales averages included in the selected particular annual report are used in generating summary information for the results set. An interactive field 510 enables the user to select a total number of extended warranty product sales to be applied to the summary tab section 544. For example, this interactive field 510 is initially populated with a default value of 50 extended warranty product sales, or, for example, 50 vehicle service contracts or VSC's. An ‘Apply VSC's by’ drop-down menu 512 enables the user to select whether the quantity of VSC's selected in the interactive field 510 is to be applied to a grand total of all vehicles in the results set, or to each individual make of vehicle within the results set.

Preferably, the top portion 502 also includes a series of drop-down menus 514-526 designed to enable the user to select the type of information to be displayed in the summary and detail sections of the center portion 504 (described in detail below). In particular, menus are provided relating to each of the following values: make, origin, N/EE/U (relating to whether the vehicle is purchased new, under the vehicle's original manufacturer's warranty, or used), plan, term, deductible, and mileage. By selecting a particular value in any of the menus 514-526, the results set displayed will include only those records including the selected particular value. If any of the menus 514-526 are left blank, the results set generated will include all records of that type. A series of check boxes 528-540 are provided in association with the menus 514-526. Preferably, each of the checked boxes 528-540 is checked by default. By deselecting any of the check boxes 528-540, the user instructs the system to provide a results set excluding the value selected in the associated drop-down menu.

Once selections have been made in fields 508-540, a ‘Refresh’ button 542 must be selected by the user. Upon selection of this refresh button 542, the system initially displays the requested data in the summary tab section 544 of the center portion 504. Referring specifically to the center portion 504, there are preferably provided a plurality of tab sections 544-554 each associated with a particular data display area. Tabs sections 544-554 specifically relate to the following information, respectively: ‘Summary’, ‘Details’, ‘Reports’, ‘Rpt Table 5’, ‘Rpt Table 6’, and ‘Un-rated’.

The ‘Summary’ tab section 544 and the ‘Details’ tab section 546 each include general and specific information relating to the particular results set displayed according to the selections made in the top portion 502. The ‘Reports’ tab section 548 enables the user to generate one or more written reports relating to the results set in a plurality of formats. The ‘Rpt Table 5’ tab section 550 and the ‘Rpt Table 6’ tab section 552 each includes specific information used by the system in generating the reports selectable in the tab section 548. Lastly, the ‘Un-rated’ tab section 554 includes information on all records which could not be processed due to errors. By selecting one of the option buttons for each product, records where errors were generated are displayed. The nature of the error for each un-rated record is listed for user review.

Relating now to the bottom portion 506, a drop-down menu 556 is provided including a listing of available optimizing criteria. In making the product comparisons, the system rates each product against each line of coverage where the specified ‘Model Year’ matches. This often produces more than one coverage being applied to each product. By selecting a specific optimizing criteria, the user is able to eliminate the duplicated products according to the selected optimizing criteria. Combinations of optimizing criteria are predefined within a drop-down menu 556 and applied by clicking an ‘Optimize by’ button 558. A plurality of fields preferably used for optimization include: a ‘Coverage’ (Plan) field, a ‘Term’ field, a ‘Miles’ field, and a ‘Price’ (Product 1 Rate or Product 2 Rate) field.

For example, with reference to extended warranty products for motor vehicles optimizing criteria combinations can be applied as follows: 1) a Coverage/Term-Miles combination (this combination selects the most comprehensive extended warranty product coverage, then the extended warranty product having the longest term, then the extended warranty product covering the most miles); 2) a Coverage/Miles-Term combination (this combination selects the most comprehensive extended warranty product coverage, then the most extended warranty product covering the most miles, then the extended warranty product having the longest term); 3) a Miles/Coverage-Term combination—(this combination selects the extended warranty product covering the most miles, then the extended warranty product having the most comprehensive coverage, then the extended warranty product having the longest term); 4) a Miles/Term-Coverage combination (this combination selects the extended warranty product covering the most miles, then the extended warranty product having the longest term, then the extended warranty product having the most comprehensive coverage); 5) a Term/Coverage-Miles combination (this combination selects the extended warranty product having the longest term, then the extended warranty product having the most comprehensive coverage, then the extended warranty product covering the most miles); 6) a Term/Miles-Coverage combination (this combination selects the extended warranty product having the longest term, then the extended warranty product covering the most miles, then the extended warranty product having the most comprehensive coverage); 7) a Product 1 Savings criteria (this optimization criteria selects a record where a value of an extended warranty product 2 rate less an extended warranty product 1 rate is largest); 8) a Product 2 Savings (this optimization criteria selects a record where a value of an extended warranty product 1 rate less an extended warranty product 2 rate is the largest); and 9) a +Deductible combination (this combination is similar to combinations 1-6 where the lowest deductible option is also considered).

Relating specifically to the ‘Summary’ tab section 544, the majority of information in the summary tab section 544 is preferably displayed in a table 560 which includes the following columns: a Make column; a General Model column (relating to a general or a grouped value description from ‘National Sales Averages’ (NSA) data): a sales and a percent of sales column (calculated totals based upon NSA data): a product 1 and a product 2 rates column (average rate values calculated by the system): a rate differential column (a calculated difference between the product 1 rate and the product 2 rate): a product 1 and a product 2 total column (average calculated rate times the total number of sales); and a product 1 savings/(cost) column (a positive or a negative value of the product 2 total less the product 1 total). A plurality of rows of the table 560 are accordingly populated with particular information relating to each distinct record. A comparison totals section 562 includes a plurality of totals for the data being displayed in the table 560. As different criteria are selected and refreshed in the top portion 502, the totals displayed are recalculated.

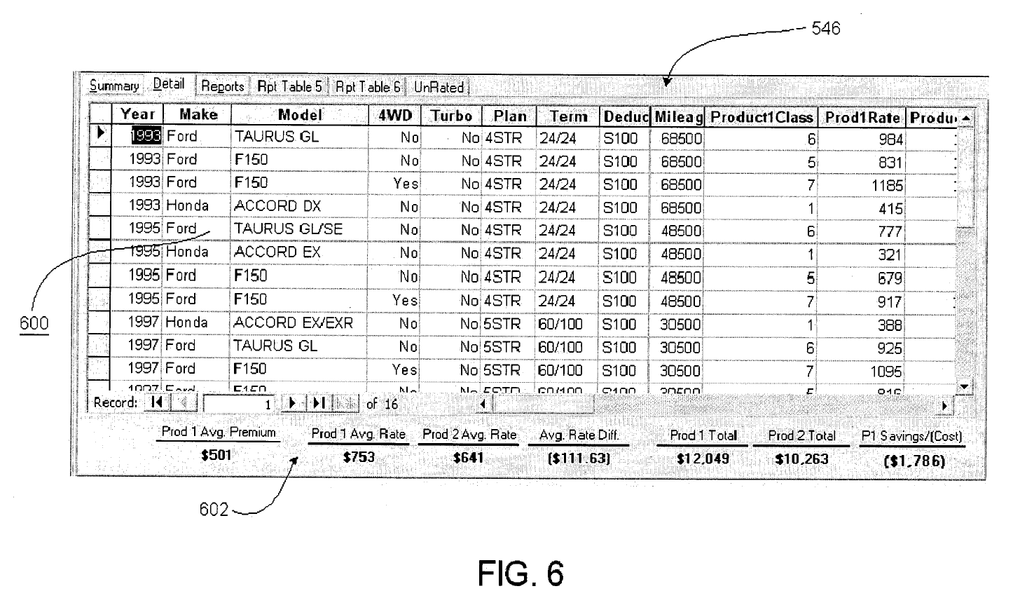

Referring now to FIG. 6, there is shown one embodiment of a ‘Details’ tab section 546. In particular, the ‘Details’ tab section 546 includes a table 600 including detailed vehicle and rate information for each individual product in the results set. As with the ‘Summary’ tab section 544 described above, a comparison totals section 602 is provided for displaying the totals for the displayed records.

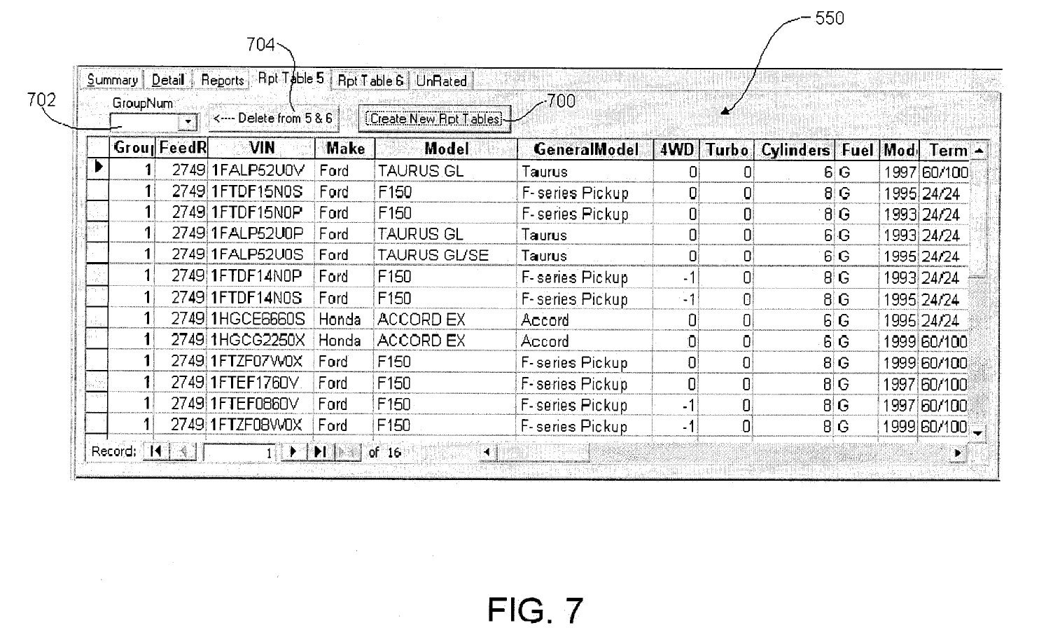

Referring now to FIG. 7, there is shown one embodiment of a ‘Rpt Table 5’ tab section 550. Once a selection of data has been defined through the top portion 502, and the optimizing portion 506, the selected data is ready to be used in creating a report. A user selection of a ‘Create New Rpt Tables’ button 700 on the ‘Rpt Table 5’ tab section 550 enables creation of a report including the selected data. When the ‘Create New Rpt Tables’ button 700 is selected, data displayed in the ‘Details’ tab section 546 is copied from the ‘Details’ tab section 546 and inserted into the ‘Rpt Table 5’ tab section 550, replacing the previous content. Simultaneously, data displayed in the ‘Summary’ tab section 544 is copied into the ‘Rpt Table 6’ tab section 552, replacing its previous content.

In a preferred embodiment, specific data sets may be added to and deleted from the reporting tables. By using the ‘Append Rpt Tables’ button 560 in FIG. 5, the user may append a current data set onto an existing report table, rather than replace existing data. Each data set used to create the report table is assigned a sequential group of numbers, beginning with one (1) when this ‘Create New Rpt Tables’ button 700 is used. If the user chooses to delete one of the data sets, the group number associated with the selected data set is selected from a drop-down menu 702 of the ‘Rpt Table 5’ tab section 550. Then, by selecting a ‘Delete from 5 & 6’ button 704, the data associated with the selected group number is deleted from the report table.

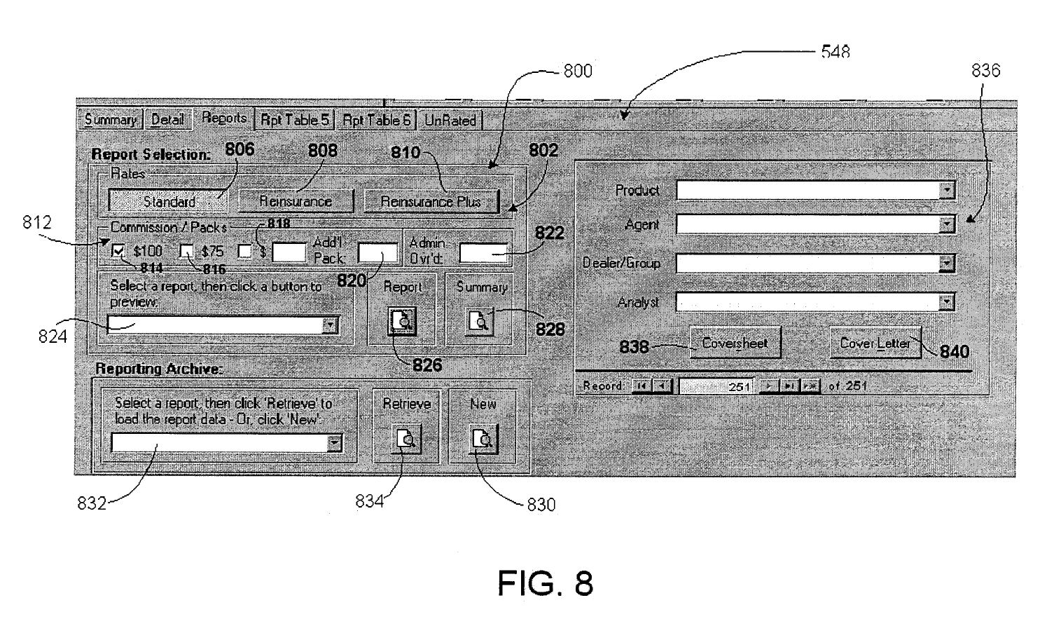

Once the report table having the desired combination of data has been built, the user selects the ‘Report’ tab section 548 to format and generate the actual report. Referring now to FIG. 8, there is shown one embodiment of a ‘Reports’ tab section 548. Within each of the reports, various field values and calculations affecting totals displayed are based upon selections made within a ‘Report Selection’ box 800 regarding rate types, commissions, packs and administrative fees.

Relating to a ‘Rates’ section 802, the user must select from a variety of preselected rate types including a standard rate type, a reinsurance rate type, and a reinsurance plus rate type by using buttons 806-810. A standard rate type uses the product rates as originally calculated through the rating process described above. The only adjustments to the values are those specified in a ‘Commissions/Packs’ section 812. A reinsurance rate type adjusts commissions in the same manner as the standard rate type, and adjusts the original rates calculated by replacing an initial administrative fee with an administrative fee override value specified in the ‘Commissions/Packs’ section 812. A reinsurance plus rate type works the same as the reinsurance rate type, however, the system adjusts the rate to include an additional 7% of a premium value.

The ‘Commissions/Packs’ section 812, includes a plurality of interactive option fields for receiving one or more user adjustments to the predefined rate types. In particular, the user is given a $100 option field 814, a $75 option field 816 and one variable option field 818 for applying a commission to the rates, as well as an option to add a ‘Pack’ commission in a ‘Pack’ commission option field 820. Any values selected by the user in these option fields override values saved when processing rates. Additionally, an ‘Admin. Override’ option field 822 enables the user to adjust the original rates calculated by substituting a particular administrative fee value for the initial value included in the results.

A report selection drop-down menu 824 includes a listing of all the available types of reports which may be generated based upon the selected results. The available reports typically fall under one of two types, a Standard report type and a Custom report type. The Standard report type is used when specific details regarding the products to be covered by an extended warranty product to be used are not provided. For example, in the context of an extended warranty product for a motor vehicle, a standard VSC coverage and an assumed vehicle mileage value are applied. In this case, generally only a total count of estimated VSC sales is provided to base the reports upon. The custom report type is used when specific details regarding the motor vehicles to be used are provided. Within the custom report, each motor vehicle is listed individually, and generally has a unique mileage that is provided.

Alternatively, a Rate-by-Rate Report and a Dealer Commission Report may be generated. The Rate-by-Rate reports is used when specific details regarding the motor vehicles to be used are not provided, but no VSC sales totals are to be applied to the motor vehicles. It provides a rate-by-rate comparison of each motor vehicle in the file only, and generally does not have subtotals or grand totals in the report. The Dealer Commission Report is a variation of the above types (Standard, Custom, and Rate-by-Rate) and includes a calculation of a retail value to determine profitability, instead of basing profitability on a cost to the motor vehicle dealership.

Each of the available reports generally may be displayed in several manners. In particular, the user may select a particular sort order for the report. For example, by selecting a “Make” sort order, the records within the report are grouped by motor vehicle ‘Make’. Also, the user may select whether to include totals with the report.

Once a particular type of report has been selected, the user may choose to view the entire report or a summary of the report. By selecting a ‘Report’ button 826, the system generates the selected report and displays a detailed listing of all available data. Upon receiving a ‘Summary’ button 828 selection, the system generates a summary of the selected report and suppresses many of the details of the report. Whether the ‘Report’ button 826 or the ‘Summary’ button 828 has been selected, the user may review and print the generated report.

Because the creation of a new report deletes any previous report data, a report archiving feature is provided to enable the user to save particular report data. By selecting a ‘New’ button 830, the user is presented with a new file name entry box. Upon receipt of a new file name input by the user, the system saves the report table information to an archive file. If the user desires to review a previously saved report, the user may select a desired previously saved report from a ‘Select a Report’ dropdown menu 832 and click a ‘Retrieve’ button 834. In response, the system retrieves the selected report from the archive file, and replaces the current report tables with the data from the retrieved report.

As should be understood in the art, a profitability analysis report is generally prepared for a presentation to a specific dealer, agent and/or group. A plurality of headers within the report and supplemental materials may be included with the report to customize the report (e.g., the report may be customized to display a business name that is specific to a recipient of such a presentation). The information related to these headers may be input in a box 836. In particular, the system may receive information relating to a particular extended warranty product 2 being reviewed; a name of an agency requesting the presentation; a name of a business being presented with the information; and a name of an analyst preparing the presentation. Preferably, the information is selected from drop-down menus including all available information.

If the user selects a ‘Coversheet’ button 838, the system generates a printable coversheet for the final report that is to be presented, displaying the data as selected. Similarly, if the user selects a ‘Cover Letter’ button 840, the system generates a printable form letter to send with the final report, displaying the data as selected, with additional general information regarding the request for a report.

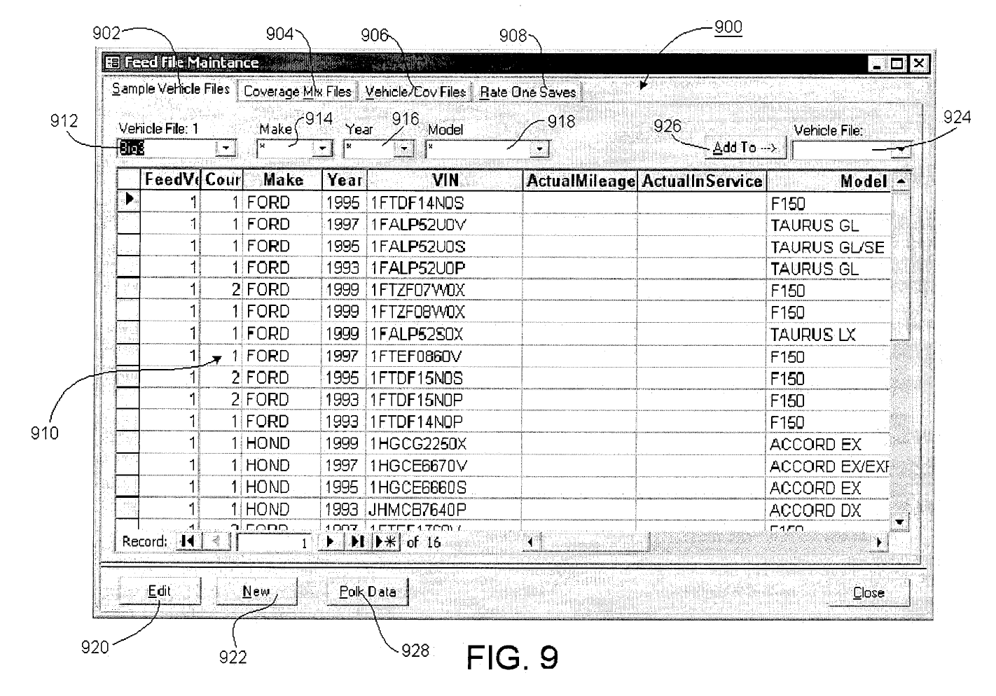

Referring now to FIG. 9, there is shown one embodiment of a GUI 900 for enabling the user to create or modify data files in accordance with the present invention. Upon receiving a user selection to view and manage the various data files used by the system, the GUI 900 is displayed to the user. The GUI 900 includes a series of display sections 902-908 each having an associated tab related to sample product files (such as sample motor vehicle files), coverage mix files, vehicle/coverage files, and rate one saves, respectively. By selecting a particular section's corresponding tab, the associated display section is brought forward for viewing and modification.

In particular, the display section 902, shown in FIG. 9, enables the user to view and manage the sample motor vehicle files relating to the particular collections of motor vehicles to be used in conducting extended warranty product comparisons. In use, collections of motor vehicles would relate specifically to a motor vehicle dealer's past or present inventory or a standardized collection of popular motor vehicles. A plurality of drop-down menus are provided on a top portion of the display section 902 to enable users to select a particular file and the motor vehicles to display in a table 910. In particular, a drop-down menu 912 includes a user-selectable listing of all previously established motor vehicle collections. Upon selecting a previously established collection, the user may restrict the display by selecting particular makes, years, and models from a plurality of dropdown menus 914, 916, and 918, respectively. By default, all motor vehicles included in the selected collection are displayed. Once a collection of vehicle information has been selected, the information is displayed in the table 910. The user may edit the content of the file by clicking on an ‘Edit’ button 920. The selection of the ‘Edit’ button 920 unlocks the table 910 and permits modification/entry of information in the table 920.

Alternatively, by selecting a ‘New’ button 922, the user may create a new vehicle feed file. In response to the selection of the ‘New’ button 922, the system displays a ‘New Vehicle File’ screen wherein the user enters a desired name for the new motor vehicle file and a description of the new motor vehicle file. Upon entry of this information, the user is returned to the display section 902. At this point, the new motor vehicle file is unpopulated and may be populated with information in a variety of manners. In one manner, the new motor vehicle file may be populated by adding selected information from previously saved motor vehicle files thereto. For example, the user, in the manner set forth above, may select to view a particular collection of motor vehicle information. Then, by selecting the new vehicle file name in a dropdown menu 924 and clicking an ‘Add to →’ button 926, the selected information is added to the new motor vehicle file.

Alternatively, the user may select the new motor vehicle file from the drop-down menu 912. Then, after selecting the ‘Edit’ button 920, the user may manually enter motor vehicle information into the table 910. To assist in identifying vehicle criteria necessary for the file's completeness, the display section 902 includes a ‘Polk Data’ button 928. By selecting this Polk Data button, a Polk Data interface is displayed, wherein the user may search for particular motor vehicle information, such as its VIN.

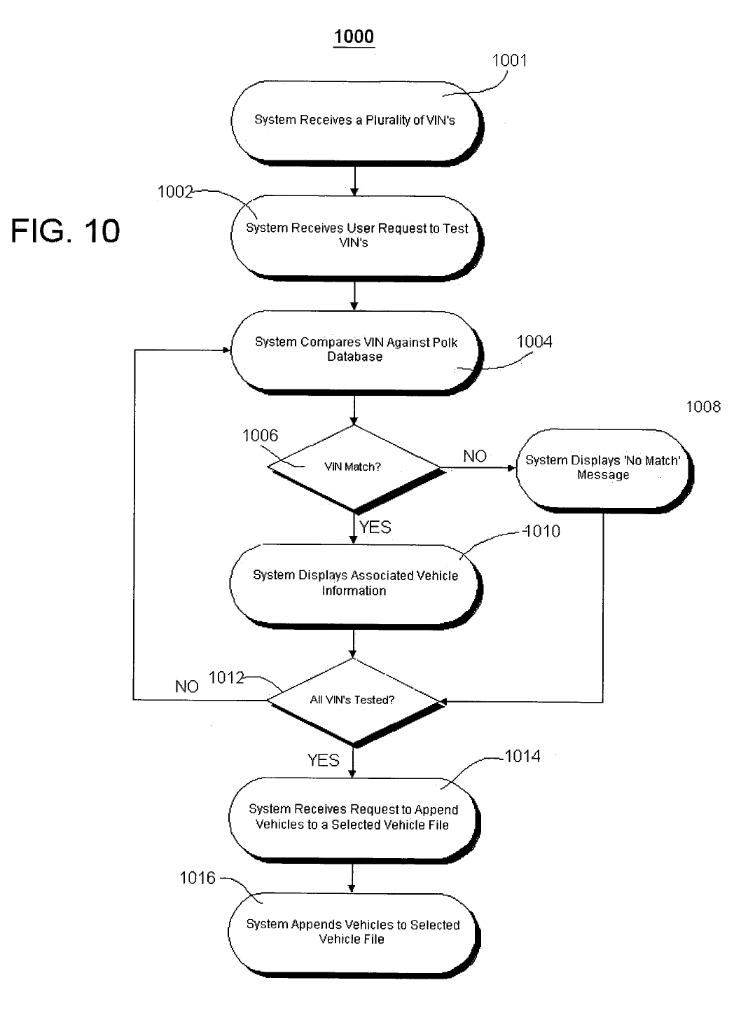

In an effort to assist the user in quickly and easily creating accurate motor vehicle feed files, one embodiment of the system of the present invention also provides an interface for simultaneously retrieving information relating to a plurality of VIN's. Referring now to FIG. 10, there is shown a flow chart describing a method 1000 for building or appending motor vehicle feed files in accordance with the present invention. In step 1001, the system receives a plurality of VIN's relating to a specific collection of motor vehicles. The VIN's may be received in any suitable manner, including a comma delineated list, a spreadsheet row or a column, etc. Upon receipt of the VIN's, the system, in step 1002, receives a user request to test the VIN's against the Polk database. In step 1004, the system compares the first received VIN against the Polk database. In step 1006, the system determines whether the received VIN matches a Polk database entry. If not, in step 1008, the system displays an error message relating to the comparison and continues to step 1012. However, if the received VIN is properly matched against a Polk database entry, the system, in step 1010, displays the motor vehicle information associated with the received VIN.

In step 1012, the system determines whether all submitted VIN's have been tested. If not, the system returns to step 1004 and compares the next received VIN against the Polk database. However, if all received VIN's have been tested, the system continues to step 1014 where it receives a user request to append the retrieved motor vehicle information to a selected motor vehicle feed file. In step 1016, the system appends the motor vehicle information to the selected motor vehicle feed file for subsequent use in conducting mass rate comparisons in the manner set forth above.

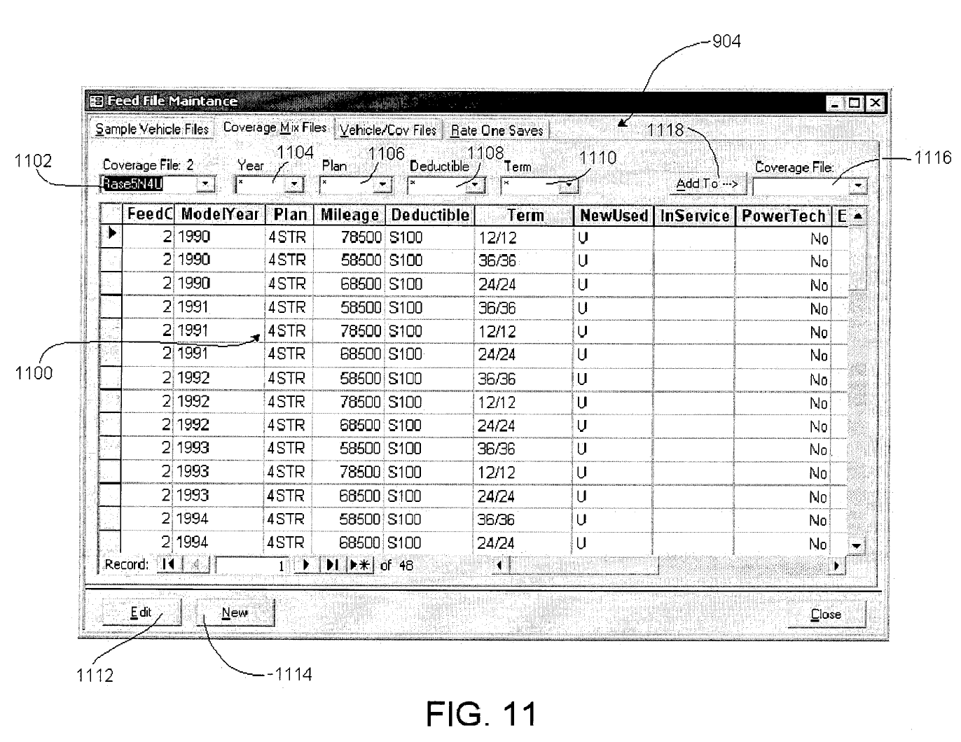

Referring now to FIG. 11, there is shown one embodiment of a coverage mix file display section 904. The coverage mix file display section 904, enables the user to view and manage the coverage mix files relating to the particular mix of extended warranty product coverages to be applied in conducting extended warranty product comparisons. For example, if a comparison between two extended warranty products for a range of coverages is desired, the coverage mix file would include designations as to the types of coverages to be compared. As with the display section 902, a plurality of drop-down menus are provided on a top portion of the display section 904 for enabling the user to select a particular coverage mix file to display in a table 1100. In particular, a drop-down menu 1102 includes a user-selectable listing of all previously established coverage mix files. Upon selecting a previously established coverage mix file, the user may restrict the display by selecting a particular application year, a plan type, a deductible amount, and a term from a plurality of drop-down menus 1104, 1106, 1108, and 1110 respectively. By default, all coverage types included in the selected collection are displayed. Once a collection of coverage type information has been selected, the information is displayed in the table 1100. The user may edit the content of the selected coverage mix file by clicking on an ‘Edit’ button 1112. This unlocks the table 1100 and permits modification/entry of information in the table 1100.

Alternatively, by selecting a ‘New’ button 1114, the user may create a new coverage mix file. In response to the selection of the ‘New’ button 1114, the system displays a ‘New Coverage File’ screen wherein the user enters a desired name for the new coverage mix file and a description of the new coverage mix file. Upon entry of this information, the user is returned to the file display section 904. At this point, the new coverage mix file is unpopulated and may be populated with information in a variety of manners substantially similar to those described for the motor vehicle files above.

In one manner, the new coverage mix file may be populated by adding selected information from previously saved coverage mix files thereto. For example, the user, in the manner set forth above, may select to view a particular coverage mix file. Then, by selecting the new coverage mix file name in a drop-down menu 1116 and clicking an ‘Add to →’ button 1118, the selected information is added to the new coverage mix file. Alternatively, the user may select the new coverage mix file from the drop-down menu 1102. Then, after selecting the ‘Edit’ button 1110, the user may manually enter coverage type information into the table 1100.

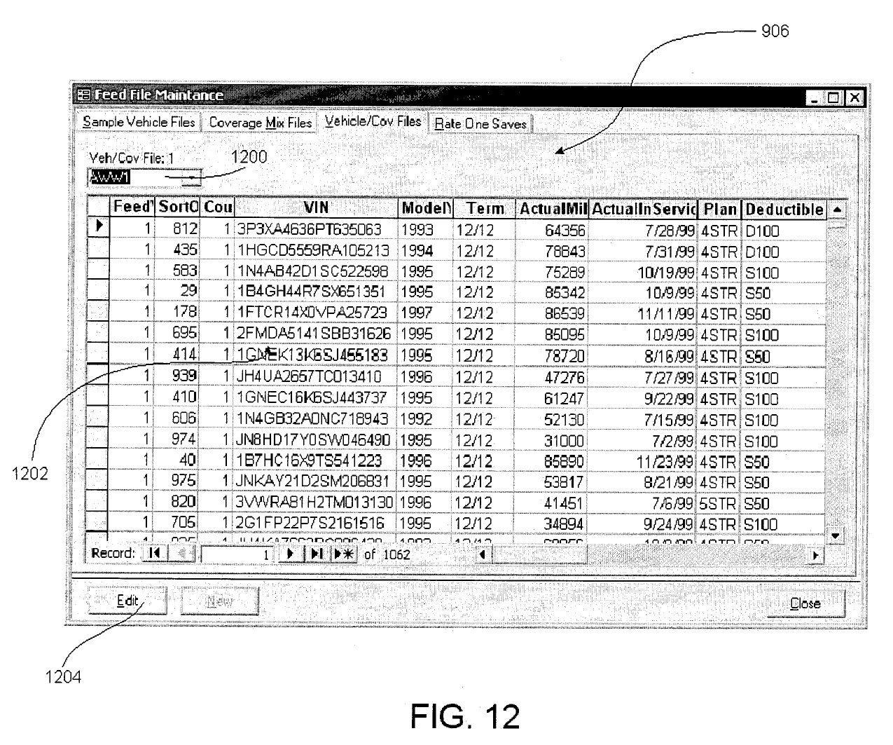

Referring now to FIG. 12, there is shown one embodiment of a vehicle/coverage file display section 906. The vehicle/coverage file display section 906 enables the user to view and manage a plurality of combined vehicle/coverage files which include information relating to both specific motor vehicles and specific coverage types. A drop-down menu 1200 is provided and includes a user-selectable listing of all previously established vehicle/coverage files. Upon selecting a previously established vehicle/coverage file, the system displays the selected information in a table 1202. The user may edit the content of the selected previously established motor vehicle coverage file by clicking on an ‘Edit’ button 1204. This unlocks the table 1202 and permits modification/entry of information in the table 1202.

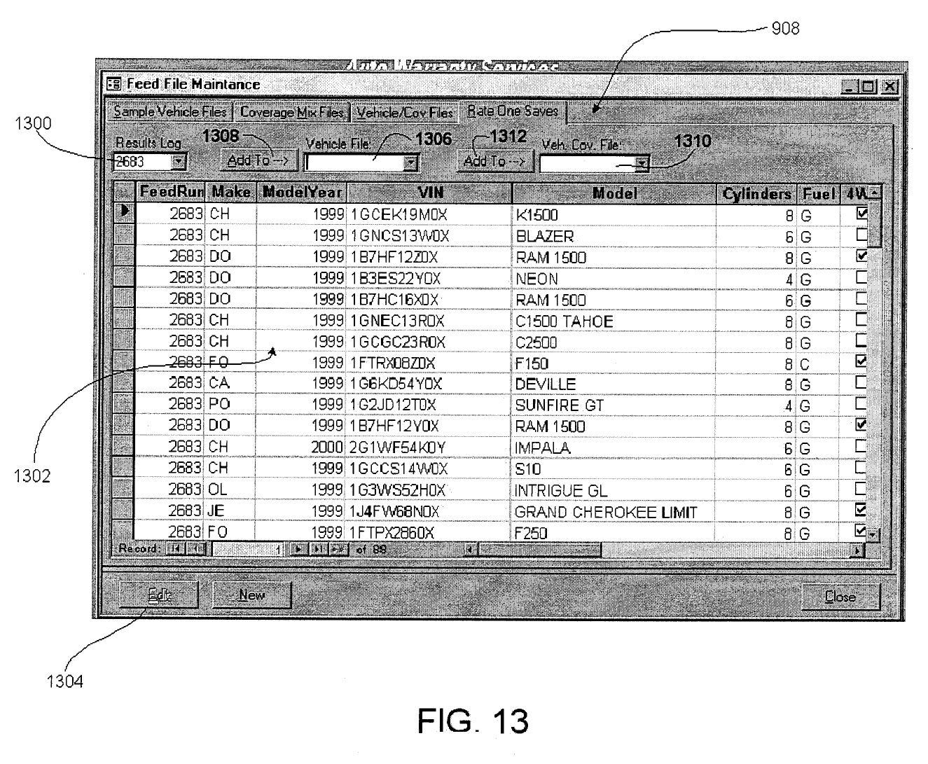

Referring now to FIG. 13, there is shown one embodiment of the rate one saves display section 908. The rate one saves display section 908 enables the user to view and manage the results log information previously saved during the process set forth above in FIG. 2. This saved results log information relates to a previously conducted comparison between selected extended warranty products for a particular motor vehicle. A drop-down menu 1300 is provided and includes a listing of all previously saved results logs. Upon selecting a particular previously saved results log, the information is displayed in a table 1302. The user may edit the content of the selected previously saved results log by clicking on an ‘Edit’ button 1304. This unlocks the table 1302 and permits modification/entry of information in the table 1302.

The motor vehicle information contained in the table 1302 may be added to a selected motor vehicle file by selecting a particular motor vehicle file from a drop-down menu 1306 and clicking an ‘Add To→’ button 1308. Similarly, the vehicle/coverage information contained in the table 1302 may be added to a selected vehicle/coverage mix file by selecting a particular vehicle/coverage file from a dropdown menu 1310 and clicking an ‘Add To→’ button 1312.

Although preferred data has been described above in association with each of the accompanying figures, it should be understood that the specific data requested and inserted into the various screens should not be limited to the above-described embodiments. Rather, it should be understood that any data useful to the industry may be requested and received. In this manner, the system of the present invention provides a single uniform interface for enabling users to conduct warranty product comparisons as well as ancillary practices such as VIN identification, etc.

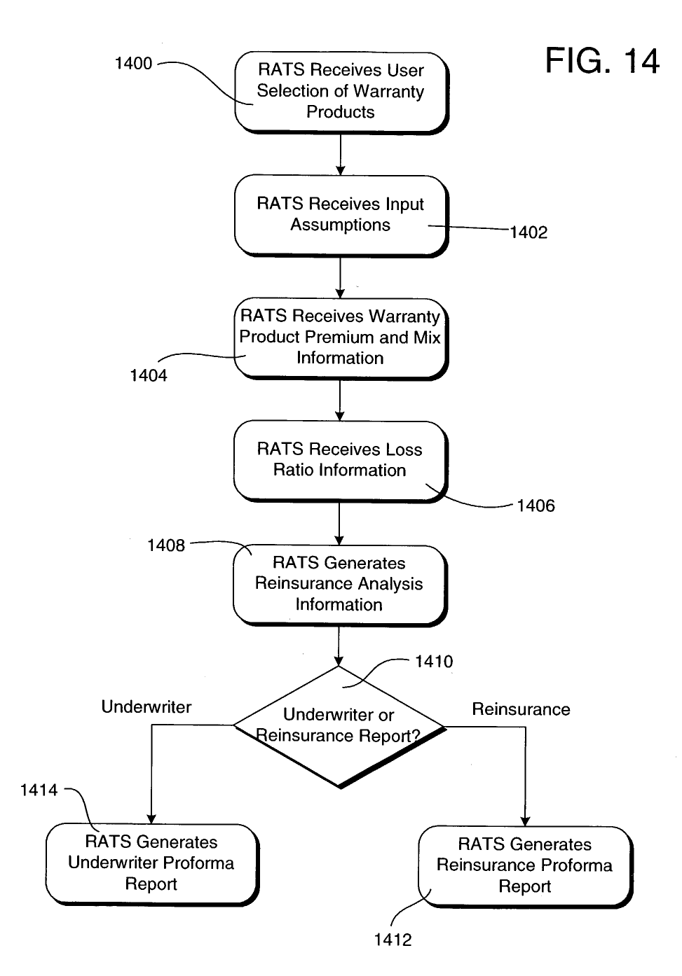

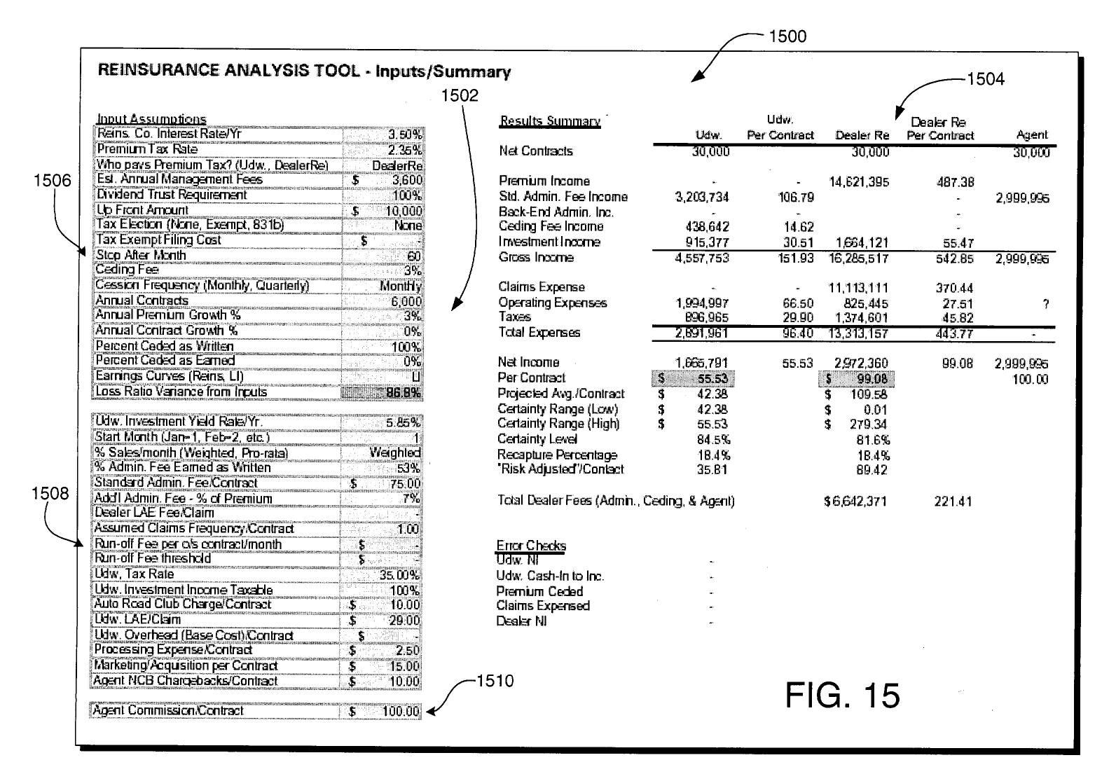

Referring now to FIG. 14, there is shown a flow chart describing the steps performed in one embodiment of a method for generating reinsurance information in association with the warranty product comparison information described in detail above. In particular, in step 1400, a computer software reinsurance analysis tool (RATS) receives a user selection of various warranty products to be analyzed. As set forth in detail above, automotive extended warranty products are typically offered in a wide variety of types, based upon the status of the vehicle to be warranted and the term (years/in service miles) of the product being purchased. Next, in step 1402, input assumptions are received relating to various elements of operating a reinsurance provider business as well as assumptions relating to the underwriting company which supports the reinsurance provider. Additional details regarding these assumptions will be set forth below in FIG. 15.

Once the input assumption information has been received, warranty product premium and vehicle mix information is received from the extended warranty product comparison system described in detail above in step 1404. This information may be either manually entered by a user or electronically retrieved from the warranty product comparison system. Next, in step 1406, loss ratio information is received for each of the warranty products being analyzed. Loss ratio refers to the percentage of a product's premium which historically is paid out in claims over the life of the product. For example, if a product's premium is $500.00 and it's loss ratio is 85%, it is expected that $425.00 of the premium amount will be paid out in claims. Correspondingly, all costs and profits must be realized based upon the expected remainder of $75.00.

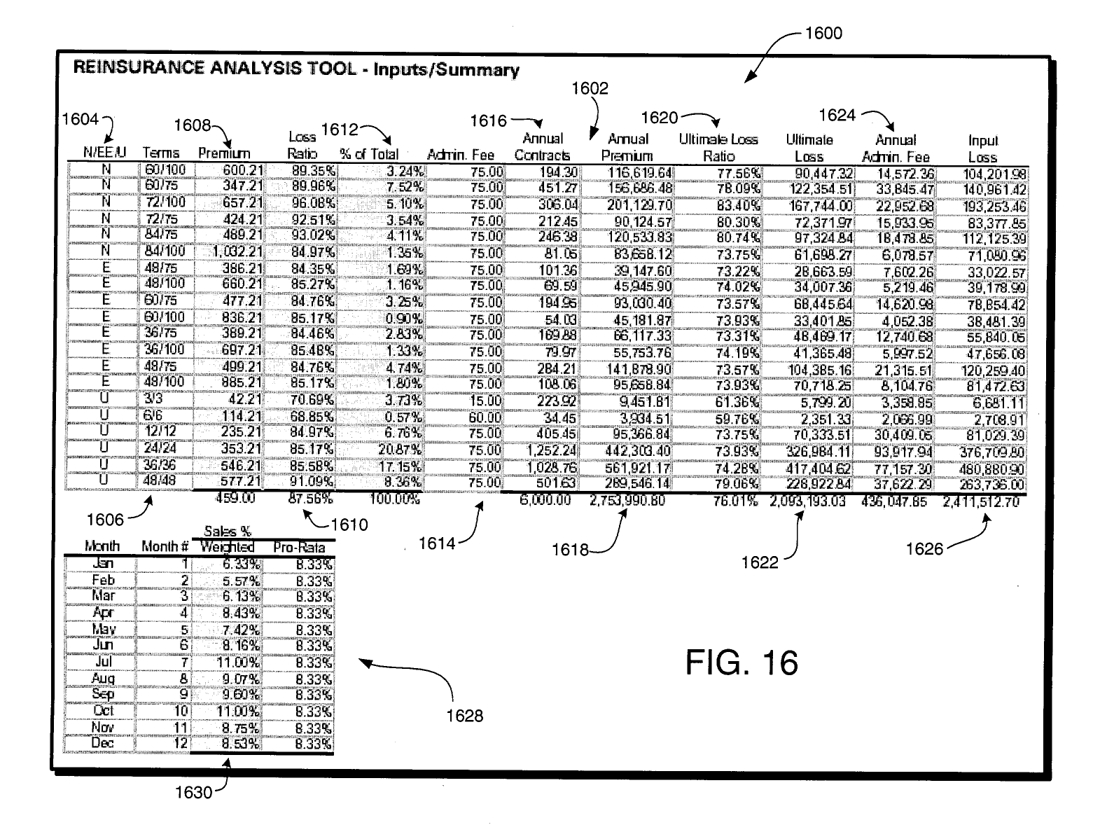

Once all input assumption, premium, mix and loss ratio information has been received, the system operates to generate a plurality of reinsurance analysis information for the included warranty products in step 1408. In a preferred embodiment (such as that shown in FIG. 16), such information includes, for each warranty product as well as in total, the following: the number of annual contracts, the annual premiums received, the ultimate loss ratio, the ultimate loss, the annual administrative fee, and the input loss. Ultimate loss and ultimate loss ratio refer to actuarially determined loss ratios taking additionally factors and historical elements into account. Historically, it has been determined that these loss ratio's reduce expected loss by approximately 10%.

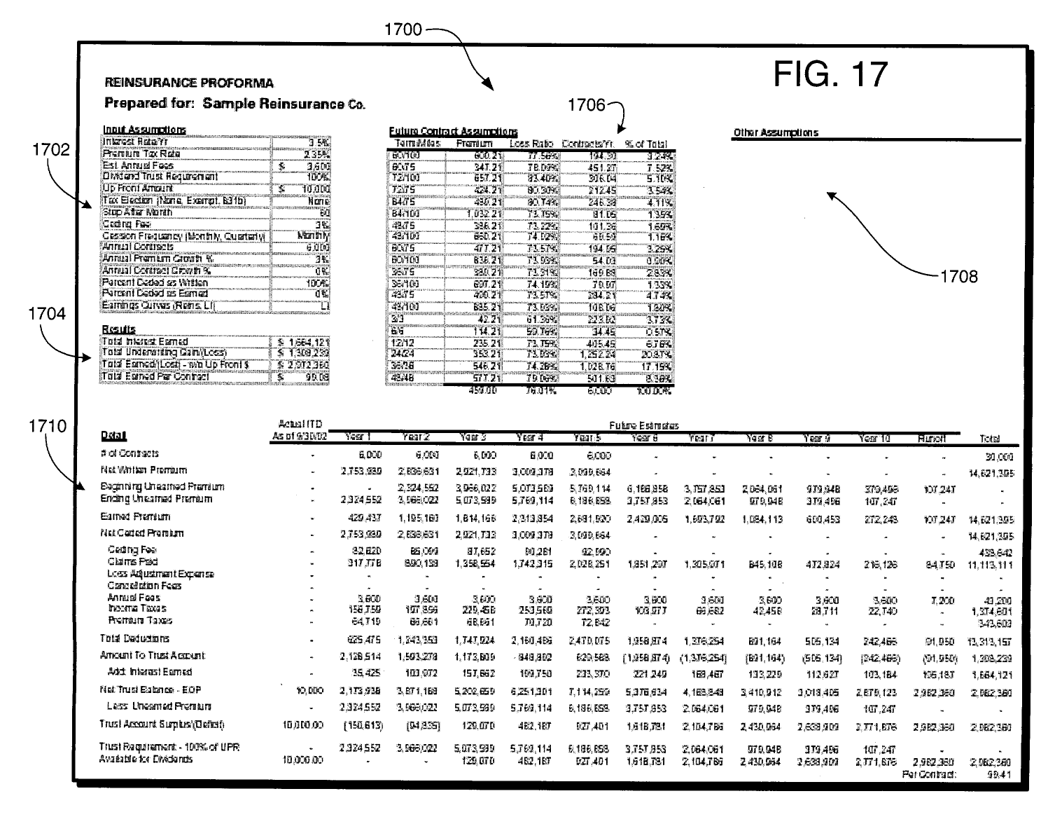

Next, in step 1410, the reinsurance analysis tool receives a user request to generate either a reinsurance proforma report to be transmitted to a potential reinsurance provider or a underwriter proforma report for use by the underwriting company. If the reinsurance proforma report is selected, a reinsurance proforma report is generated in step 1412. In a preferred embodiment (as shown in FIG. 17), the reinsurance proforma report illustrates both the relevant assumptions as well as projected income and expenses associated with offering reinsurance services for the selected variety of warranty products over a selected number of years. More particularly, the reinsurance proforma report specifically includes an estimated per contract profit useful to the potential provider in analyzing the offered products.

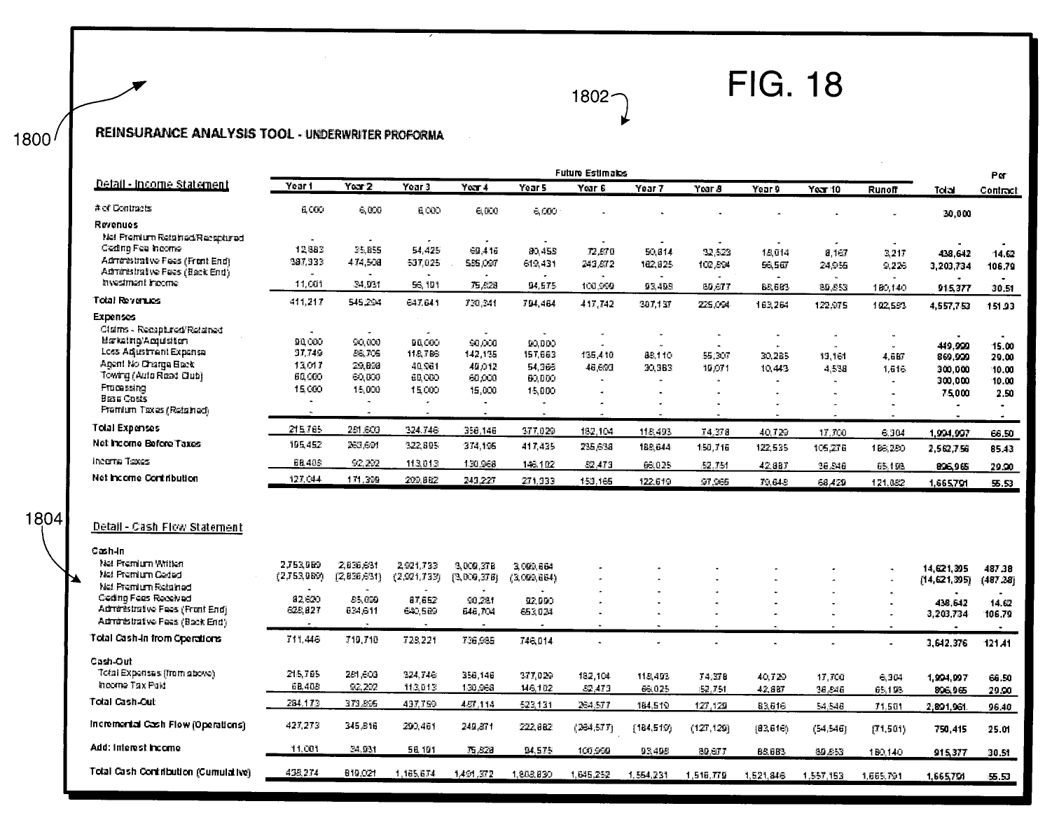

If the underwriter proforma report is selected in step 1410, a underwriter proforma report is generated in step 1414. Similar to the reinsurance proforma report, the underwriter proforma report also generates a per contract income for the warranty products selected. However, the underwriter proforma report takes various underwriter-specific costs into consideration in generating its results. A preferred embodiment of a underwriter proforma report is shown in FIG. 18.

Referring now to FIG. 15, there is shown one embodiment of a first reinsurance analysis tool input/summary display section 1500. In particular, the first input/summary display section 1500 includes an input assumptions section 1502 and a results summary section 1504. Additionally, the input assumptions section 1502 also includes a reinsurance subsection 1506 for including various input assumptions relating to the reinsurance provider and an underwriter subsection 1508 for including various input assumptions relating specifically to the underwriter.

In a preferred embodiment, the following reinsurance provider-related input assumptions are provided: the reinsurance co. interest rate per year; the premium tax rate; an indication as to who pays the premium tax (underwriter or reinsurance co.); the dividend trust requirement (relates to how much of the income must stay within the company); the up front amount (relates to money required from the reinsurance co. to start operations); an indication regarding the tax election status (none, exempt, 831b); the tax exempt filing costs (if any); the stop after month; the ceding fee (the amount retained by the underwriter to account for risk); the cession frequency (monthly quarterly); the number of annual contracts expected; the expected annual premium growth percentage; the expected annual contract growth percentage; the percent of the premium ceded at the time of contract writing; the percent of the premium ceded at the time of earning; an indication as to the earnings curve methodology to be applied (reinsurance or loss incidence); and the loss ratio variance from inputs.

Additionally, in a preferred embodiment, the following underwriter-related input assumptions are provided: the underwriter investment yield rate per year; the starting month of the analysis; an indication regarding whether contract sales are to be weighted by month or prorated for the entire year; the percentage of the administrative fee to be earned as written; the standard administrative fee for each contract; the additional administrative fee as a percentage of premium; the reinsurance co. loss adjustment expense fee per claim; the number of assumed claims frequency per contract; the run-off fee per outstanding contract per month (a fee associated with a reinsurance companies lag in expected contracts); the run-off fee threshold; the underwriter tax rate; the percentage of underwriter investment income that is taxable; the cost per contract for the auto road club; the underwriter loss adjustment expense fee per claim (administrative cost to underwriter per claim); the underwriter base cost per contract; the underwriter processing expense per contract; the underwriter marketing and acquisition cost per contract; and the cost of agent NCB (no chargebacks) per contract.

An agent commission/contract subsection 1510 is also provided for identifying the agent commission per contract to be applied to the analysis. Each input assumption described above may be directly input into the reinsurance analysis tool software program by a user or retrieved electronically from another software program, where suitable. Accordingly, the entered information may then be utilized in generating the summary information described above.

Specifically relating to the results summary section 1504, brief summary analysis information is preferably provided in a tabular format for each interested entity: the underwriter, the reinsurance company, and the agent, with per contract information being provided for the underwriter and the reinsurance company. Further the information contained within the results summary section 1504 is populated using both the information in the input assumptions section 1502 as well as information supplied and generated in the second reinsurance analysis tool input/summary display section 1600 shown in FIG. 16.

Referring specifically to FIG. 16, the second reinsurance analysis tool input/summary display section 1600 includes a first tabular section 1602 including various elements of information. In particular, columns 1604 and 1606 are provided for indicating the specific warranty product referenced, with column 1604 including the type of auto (new, extended eligibility, or used) and column 1606 including the term of the product. Columns 1608, 1610, and 1612, are provided for receiving inputs regarding product premium (1608), estimated loss ratio (1610) and vehicle mix percentage (1612) for each warranty product included in the analysis. Once such information is received (either manually or electronically from the warranty product comparison tool), it is used in combination with any relevant input assumptions to generate the remaining columns of the table. In a preferred embodiment, column 1614 relates to administrative fee, column 1616 relates to the expected number of contracts annually, column 1618 relates to the aggregate annual premium received (product premium*expected number of contracts), column 1620 relates to ultimate loss ratio (described above), column 1622 relates to the ultimate loss expected (ultimate loss ratio*annual premium), column 1624 relates to the annual administrative fee to be received (administrative fee*annual contracts), and column 1626 relates to expected input loss (loss ratio*annual premium).

Additionally, a second tabular section 1628 is preferably provided for including expected sales percentages by month on both a weighted and prorated basis. For the weighted basis figures (column 1630), sales percentages by month may be input based upon historical information and products being offered.

Referring now to FIG. 17, there is shown one embodiment of a reinsurance analysis tool results display section 1700 as generated for a sample reinsurance company. In particular, the reinsurance analysis tool results display section 1700 preferably includes six distinct sections: an input assumptions section 1702 for including the reinsurance company-related input assumption information input and shown in FIG. 15; a results section 1704 for including simplified results information from the results summary section of FIG. 15; a future contract assumptions section 1706 for including premium, loss ratio, contracts per year, and vehicle mix information for each warranty product being analyzed from the tabular information displayed in FIG. 16; an other assumptions section 1708 for including any other relevant assumptions which impact the displayed results; and a detail section 1710 for including detailed projected earnings and expense information both on an annual basis as well as in aggregate. In a preferred embodiment, the detail section 1710 includes the following results information for each year of the analysis: number of contracts; net written premium; beginning unearned premium; ending unearned premium; earned premium; net ceded premium; ceding fee; claims paid; loss adjustment expense; cancellation fee; annual fees; income taxes; premium taxes; total deductions; amount deposited into the trust account; interest earned; net trust balance; unearned premium; trust account surplus or deficit; trust requirement; and amount available for dividends.

By providing the above information in an easily disseminated and readable form, potential reinsurance providers may accurately analyze the profitability of conducting business with a given underwriter for a particular selection of warranty products.

Referring now to FIG. 18, there is shown one embodiment of a reinsurance analysis tool results display section 1800 as generated for an underwriting company. Similar to the results display section of FIG. 17, the underwriter-specific display section 1800 also includes a per year and aggregate breakdown of the income and expenses associated with doing business with a given reinsurance company for a particular selection of warranty products. In particular, display section 1800 is preferably broken down into two discrete sections: a detail—income statement section 1802; and a detail—cash flow statement section 1804. As implied the information in section 1802 relates to realized revenues and expenses and preferably includes the following: number of contracts; net premium retained/recaptured; ceding fee income; administrative fees (front end); administrative fees (back end); investment income; claims—recaptured/retained; marketing/acquisition; loss adjustment expense; agent no chargeback cost; auto road club expense; processing; base costs (overhead); premium taxes (retained); total expenses; net income before taxes; income taxes; and net income contribution. This information is also preferably displayed in a per contract format as well.

Regarding section 1804, information in this section more specifically details the cash-in for each year of the arrangement. Preferably the displayed information includes the following: net premium written; net premium ceded; net premium retained; ceding fees received; administrative fees (front end); administrative fees (back end); total cash-in from operations; total expenses (retrieved from section 1802, described above); income taxes paid; total cash-out; incremental cash flow; interest income; and total cash contribution (cumulative). As above, this information is also preferably displayed in a per contract format as well.

By providing the above information in an easily disseminated and readable form, an underwriting company may accurately analyze the potential profitability of conducting business with a given reinsurance company for a particular selection of warranty products.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A computer readable medium including a software application for enabling interactive comparison of a plurality of extended warranty products of a plurality of providers, said software application comprising:
one or more instructions for receiving extended warranty product information for at least two extended warranty products, said extended warranty product information including at least extended warranty product rate information for a plurality of products to be covered by the extended warranty products;
one or more instructions for saving said extended warranty product information;
one or more instructions for receiving a request to compare the at least two extended warranty products;
one or more instructions for receiving test case product data relating to at least one product to be covered by an extended warranty product;
one or more instructions for receiving a selection of a first extended warranty product and a second extended warranty product from the at least two extended warranty products;
one or more instructions for retrieving from said received extended warranty product information associated with said first extended warranty product and said second extended warranty product, a first extended warranty product rate and a second extended warranty product rate for said at least one product to be covered by an extended warranty; and
one or more instructions for displaying said first extended warranty product rate and said second extended warranty product rate.

2. The software application of claim 1, wherein said one or more instructions for saving said extended warranty product information further comprises one or more instructions for saving said extended warranty product information to at least one database associated with said computer readable medium.

3. The software application of claim 1, wherein said one or more instructions for receiving test case product data further comprises:
one or more instructions for displaying to a user, a data entry screen including a plurality of data entry fields for receiving information relating to said at least one product to be covered by an extended warranty product; and
one or more instructions for receiving information relating to said at least one product to be covered by an extended warranty product in said plurality of data entry fields.

4. The software application of claim 3, wherein said plurality of data entry fields include a product identification number data field.

5. The software application of claim 3, wherein said plurality of data entry fields include a motor vehicle make field, a motor vehicle model field, and, a motor vehicle year field.

6. The software application of claim 3, wherein said plurality of data entry fields further comprise:
a motor vehicle mileage field for receiving information indicative of a mileage for the motor vehicle;
a new motor vehicle field for receiving an indication as to whether the vehicle was purchased new; and
an in-service date field for receiving information indicative of a date at which the motor vehicle was first put into service.

7. The software application of claim 1, wherein said one or more instructions for receiving a selection of a first extended warranty product and a second extended warranty product from the at least two extended warranty products further comprises:
one or more instructions for displaying to a user a data entry screen including a plurality of data entry fields for receiving information relating to said first extended warranty product and the second extended warranty product; and
one or more instructions for receiving extended warranty product identification information in said plurality of data entry fields.

8. The software application of claim 7, wherein said plurality of data entry fields include:
a first extended warranty product identification field for receiving information indicative of the first extended warranty product; and
a second extended warranty product identification field for receiving information indicative of the second extended warranty product.

9. The software application of claim 8 wherein said first extended warranty product identification field and the second extended warranty product identification field are mapped together so that a selection in one of the first extended vehicle warranty product identification field and the second extended warranty product identification field results in an automatic corresponding selection in said other one of the first extended warranty product identification field and the second motor vehicle warranty product identification field.

10. The software application of claim 8, wherein said plurality of data entry fields further include:
a first coverage field for receiving information indicative of a level of coverage for the first extended warranty product;
a second coverage field for receiving information indicative of a level of coverage for the second extended warranty product;
a first deductible field for receiving information indicative of an applicable deductible for the first extended warranty product;
a second deductible field for receiving information indicative of an applicable deductible for the second extended warranty product;
a first term field for receiving information indicative of a coverage term for the first extended warranty product; and
a second term field for receiving information indicative of a coverage term for the second extended warranty product.

11. The software application of claim 10 wherein:
said first coverage field and the second coverage field are mapped together so that a selection in one of the first coverage field and the second coverage field results in an automatic corresponding selection in said other one of the first coverage field and the second coverage field;
said first deductible field and said second deductible field are mapped together so that a selection in one of the first deductible field and the second deductible field results in an automatic corresponding selection in said other one of the first deductible field and the second deductible field; and
said first term field and the second term field are mapped together so that a selection in one of the first term field and the second term field results in an automatic corresponding selection in said other one of the first term field and second term field.

12. The software application of claim 1, wherein said one or more instructions for displaying said first extended warranty product rate and said second extended warranty product rate further comprises:
one or more instructions for indicating a lower of the first extended warranty product rate and the second extended warranty product rate; and
one or more instructions for displaying a margin between the first extended warranty product rate and the second extended warranty product rate.

13. The software application of claim 1, further comprising:
one or more instructions for receiving identification information for a plurality of products to be covered by an extended warranty product;
one or more instructions for receiving extended warranty product coverage information including a plurality of different extended warranty product coverages to be applied to each extended warranty product; and
wherein said one or more instructions for displaying said first extended warranty product rate and said second extended warranty product rate includes one or more instructions for displaying a running tally of wins for each of the first extended warranty product and the second extended warranty product, wherein a win denotes a lower rate for a particular motor vehicle and coverage combination.

14. The software application of claim 13, further comprising:
one or more instructions for determining a profitability for each of said first and second extended warranty products based upon said first and second extended warranty product rates for each particular motor vehicle and coverage combination; and
one or more instructions for displaying the profitability for each of said first and second extended warranty products.

15. The software application of claim 1, further comprising:
one or more instructions for saving, as a results set, information related to the extended warranty product comparison.

16. The software application of claim 15, further comprising:
one or more instructions for receiving a user request to view summary information for a particular saved results set; and
one or more instructions for displaying said summary information, wherein said summary information includes at least an identification of the first extended warranty product and the second extended warranty product, and an indication as to the number of wins for each of the first extended warranty product and the second extended warranty product.

17. The software application of claim 15, further comprising:
one or more instructions for receiving a user request to view detail information for a particular saved results set; and
one or more instructions for displaying said detail information, wherein said detail information includes specific information relating to the first extended warranty product rate and the second extended warranty product rate for each of the at least one product to be covered by an extended warranty product.

18. The software application of claim 1, further comprising:
one or more instructions for receiving a user request to generate a report of the comparison;
one or more instructions for generating a report of the comparison; and
one or more instructions for displaying the report to the user.

19. The software application of claim 18, wherein said report includes a profitability for each of said first and second extended warranty products based upon said first and second extended warranty product rates for each particular motor vehicle and coverage combination.

20. A method for enabling interactive comparison of a plurality of extended warranty products of a plurality of providers, comprising the steps of:
receiving extended warranty product information for at least two extended warranty products, said extended warranty product information including at least extended warranty product rate information for a plurality of products to be covered by the extended warranty products;
storing said extended warranty product information for subsequent retrieval and use;
receiving a request to compare the at least two extended warranty products;
receiving test case product data relating to at least one product to be covered by an extended warranty product;
receiving a selection of a first extended warranty product and a second extended warranty product from the at least two extended warranty products;
retrieving from said received extended warranty product information associated with said first extended warranty product and said second extended warranty product, a first extended warranty product rate and a second extended warranty product rate for said at least one product to be covered by an extended warranty; and
displaying said first extended warranty product rate and said second extended warranty product rate.

21. The method of claim 20, wherein said step of storing said extended warranty product information further comprises the step of storing said extended warranty product information on at least one database.

22. The method of claim 20, wherein said step of receiving test case product data further comprises the steps of:
displaying to a user, a data entry screen including a plurality of data entry fields for receiving information relating to said at least one product to be covered by an extended warranty product; and
receiving information relating to said at least one product to be covered by an extended warranty product in said plurality of data entry fields.

23. The method of claim 22, wherein said plurality of data entry fields include a product identification number data field.

24. The method of claim 22, wherein said plurality of data entry fields include a motor vehicle make field, a motor vehicle model field, and, a motor vehicle year field.

25. The method of claim 22, wherein said plurality of data entry fields further comprise:
a motor vehicle mileage field for receiving information indicative of a mileage for the motor vehicle;
a new motor vehicle field for receiving an indication as to whether the vehicle was purchased new; and
an in-service date field for receiving information indicative of a date at which the motor vehicle was first put into service.

26. The method of claim 20, wherein said step of receiving a selection of a first extended warranty product and a second extended warranty product from the at least two extended warranty products further comprises the steps of:
displaying to a user a data entry screen including a plurality of data entry fields for receiving information relating to said first extended warranty product and the second extended warranty product; and
receiving extended warranty product identification information in said plurality of data entry fields.

27. The method of claim 26, wherein said plurality of data entry fields include:
a first extended warranty product identification field for receiving information indicative of the first extended warranty product; and
a second extended warranty product identification field for receiving information indicative of the second extended warranty product.

28. The method of claim 26 wherein said first extended warranty product identification field and the second extended warranty product identification field are mapped together so that a selection in one of the first extended vehicle warranty product identification field and the second extended warranty product identification field results in an automatic corresponding selection in said other one of the first extended warranty product identification field and the second motor vehicle warranty product identification field.

28. The method of claim 26, wherein said plurality of data entry fields further include:
a first coverage field for receiving information indicative of a level of coverage for the first extended warranty product;
a second coverage field for receiving information indicative of a level of coverage for the second extended warranty product;
a first deductible field for receiving information indicative of an applicable deductible for the first extended warranty product;
a second deductible field for receiving information indicative of an applicable deductible for the second extended warranty product;
a first term field for receiving information indicative of a coverage term for the first extended warranty product; and
a second term field for receiving information indicative of a coverage term for the second extended warranty product.

29. The method of claim 28 wherein:
said first coverage field and the second coverage field are mapped together so that a selection in one of the first coverage field and the second coverage field results in an automatic corresponding selection in said other one of the first coverage field and the second coverage field;
said first deductible field and said second deductible field are mapped together so that a selection in one of the first deductible field and the second deductible field results in an automatic corresponding selection in said other one of the first deductible field and the second deductible field; and
said first term field and the second term field are mapped together so that a selection in one of the first term field and the second term field results in an automatic corresponding selection in said other one of the first term field and second term field.

30. The method of claim 20, wherein said step of displaying said first extended warranty product rate and said second extended warranty product rate further comprise the steps of:
indicating a lower of the first extended warranty product rate and the second extended warranty product rate; and
displaying a margin between the first extended warranty product rate and the second extended warranty product rate.

31. The method of claim 20, further comprising the steps of:
receiving identification information for a plurality of products to be covered by an extended warranty product;
receiving extended warranty product coverage information including a plurality of different extended warranty product coverages to be applied to each extended warranty product;
wherein said step of displaying said first extended warranty product rate and said second extended warranty product rate includes the step of displaying a running tally of wins for each of the first extended warranty product and the second extended warranty product, wherein a win denotes a lower rate for a particular motor vehicle and coverage combination.

32. The method of claim 31, further comprising the steps of:
determining a profitability for each of said first and second extended warranty products based upon said first and second extended warranty product rates for each particular motor vehicle and coverage combination; and
displaying the profitability for each of said first and second extended warranty products.

33. The method of claim 20, further comprising the step of saving, as a results set, information related to the extended warranty product comparison.

34. The method of claim 33, further comprising the steps of:
receiving a user request to view summary information for a particular saved results set; and
displaying said summary information, wherein said summary information includes at least an identification of the first extended warranty product and the second extended warranty product, and an indication as to the number of wins for each of the first extended warranty product and the second extended warranty product.

35. The method of claim 33, further comprising the steps of:
receiving a user request to view detail information for a particular saved results set; and
displaying said detail information, wherein said detail information includes specific information relating to the first extended warranty product rate and the second extended warranty product rate for each of the at least one product to be covered by an extended warranty product.

36. The method of claim 20, further comprising the steps of:
receiving a user request to generate a report of the comparison;
generating a report of the comparison; and
displaying the report to the user.

37. The method of claim 36, wherein said report includes a profitability for each of said first and second extended warranty products based upon said first and second extended warranty product rates for each particular motor vehicle and coverage combination.

38. A system for enabling interactive comparison of a plurality of extended warranty products of a plurality of providers, comprising:
means for receiving extended warranty product information for at least two extended warranty products, said extended warranty product information including at least extended warranty product rate information for a plurality of products to be covered by the extended warranty products;
means for saving said extended warranty product information;
means for receiving a request to compare the at least two extended warranty products;
means for receiving test case product data relating to at least one product to be covered by an extended warranty product;
means for receiving a selection of a first extended warranty product and a second extended warranty product from the at least two extended warranty products;
means for retrieving from said received extended warranty product information associated with said first extended warranty product and said second extended warranty product, a first extended warranty product rate and a second extended warranty product rate for said at least one product to be covered by an extended warranty; and
means for displaying said first extended warranty product rate and said second extended warranty product rate.

39. The system of claim 38, wherein means for saving said extended warranty product information further comprise means for saving said extended warranty product information to at least one database.

40. The system of claim 38, wherein said means for receiving test case product data further comprises:
means for displaying to a user, a data entry screen including a plurality of data entry fields for receiving information relating to said at least one product to be covered by an extended warranty product; and
means for receiving information relating to said at least one product to be covered by an extended warranty product in said plurality of data entry fields.

41. The system of claim 40, wherein said plurality of data entry fields include a product identification number data field.

42. The system of claim 40, wherein said plurality of data entry fields include a motor vehicle make field, a motor vehicle model field, and, a motor vehicle year field.

43. The system of claim 40, wherein said plurality of data entry fields further comprise:
a motor vehicle mileage field for receiving information indicative of a mileage for the motor vehicle;
a new motor vehicle field for receiving an indication as to whether the vehicle was purchased new; and
an in-service date field for receiving information indicative of a date at which the motor vehicle was first put into service.

44. The system of claim 38, wherein said means for receiving a selection of a first extended warranty product and a second extended warranty product from the at least two extended warranty products further comprise:
means for displaying to a user a data entry screen including a plurality of data entry fields for receiving information relating to said first extended warranty product and the second extended warranty product; and
means for receiving extended warranty product identification information in said plurality of data entry fields.

45. The system of claim 38, wherein said plurality of data entry fields include:
a first extended warranty product identification field for receiving information indicative of the first extended warranty product; and
a second extended warranty product identification field for receiving information indicative of the second extended warranty product.

46. The system of claim 45 wherein said first extended warranty product identification field and the second extended warranty product identification field are mapped together so that a selection in one of the first extended vehicle warranty product identification field and the second extended warranty product identification field results in an automatic corresponding selection in said other one of the first extended warranty product identification field and the second motor vehicle warranty product identification field.

47. The system of claim 45, wherein said plurality of data entry fields further include:
a first coverage field for receiving information indicative of a level of coverage for the first extended warranty product;
a second coverage field for receiving information indicative of a level of coverage for the second extended warranty product;
a first deductible field for receiving information indicative of an applicable deductible for the first extended warranty product;
a second deductible field for receiving information indicative of an applicable deductible for the second extended warranty product;
a first term field for receiving information indicative of a coverage term for the first extended warranty product; and
a second term field for receiving information indicative of a coverage term for the second extended warranty product.

48. The system of claim 47 wherein:
said first coverage field and the second coverage field are mapped together so that a selection in one of the first coverage field and the second coverage field results in an automatic corresponding selection in said other one of the first coverage field and the second coverage field;
said first deductible field and said second deductible field are mapped together so that a selection in one of the first deductible field and the second deductible field results in an automatic corresponding selection in said other one of the first deductible field and the second deductible field; and
said first term field and the second term field are mapped together so that a selection in one of the first term field and the second term field results in an automatic corresponding selection in said other one of the first term field and second term field.

49. The system of claim 38, wherein said means for displaying said first extended warranty product rate and said second extended warranty product rate further comprise:
means for indicating a lower of the first extended warranty product rate and the second extended warranty product rate; and
means for displaying a margin between the first extended warranty product rate and the second extended warranty product rate.

50. The system of claim 38, further comprising:
means for receiving identification information for a plurality of products to be covered by an extended warranty product;
means for receiving extended warranty product coverage information including a plurality of different extended warranty product coverages to be applied to each extended warranty product;
wherein said means for displaying said first extended warranty product rate and said second extended warranty product rate include means for displaying a running tally of wins for each of the first extended warranty product and the second extended warranty product, wherein a win denotes a lower rate for a particular motor vehicle and coverage combination.

51. The system of claim 50, further comprising:
means for determining a profitability for each of said first and second extended warranty products based upon said first and second extended warranty product rates for each particular motor vehicle and coverage combination; and
means for displaying the profitability for each of said first and second extended warranty products.

52. The system of claim 38, further comprising:
means for saving, as a results set, information related to the extended warranty product comparison.

53. The system of claim 52, further comprising:
means for receiving a user request to view summary information for a particular saved results set; and
means for displaying said summary information, wherein said summary information includes at least an identification of the first extended warranty product and the second extended warranty product, and an indication as to the number of wins for each of the first extended warranty product and the second extended warranty product.

54. The system of claim 52, further comprising:
means for receiving a user request to view detail information for a particular saved results set; and
means for displaying said detail information, wherein said detail information includes specific information relating to the first extended warranty product rate and the second extended warranty product rate for each of the at least one product to be covered by an extended warranty product.

55. The system of claim 38, further comprising:
means for receiving a user request to generate a report of the comparison;
means for generating a report of the comparison; and
means for displaying the report to the user.

56. The method of claim 55, wherein said report includes a profitability for each of said first and second extended warranty products based upon said first and second extended warranty product rates for each particular motor vehicle and coverage combination.

58. A computer readable medium including a software application for enabling interactive analysis of reinsurance business for extended warranty products, said, software application comprising:
one or more instructions for receiving a selection of at least one warranty product;
one or more instructions for receiving input assumption information;
one or more instructions for receiving premium and vehicle mix information for each of the at least one warranty product;
one or more instructions for receiving loss ratio information for each of the at least one warranty product;
one or more instructions for generating reinsurance analysis information; and
one or more instructions for displaying the reinsurance analysis information to a user.

59. The software application of claim 58, wherein the one or more instructions for receiving input assumption information further comprise:
one or more instructions for receiving reinsurance company input assumption information; and
one or more instructions for receiving underwriter input assumption information.

60. The software application of claim 59, wherein the one or more instructions for receiving reinsurance company input assumption information, further comprise at least one of:
one or more instructions for receiving a reinsurance co. interest rate per year;
one or more instructions for receiving a premium tax rate;
one or more instructions for receiving an indication as to who pays a premium tax;
one or more instructions for receiving a dividend trust requirement;
one or more instructions for receiving the up front amount required to start operations;
one or more instructions for receiving an indication regarding tax election status;
one or more instructions for receiving a tax exempt filing costs amount;
one or more instructions for receiving a stop after month indication;
one or more instructions for receiving a ceding fee amount;
one or more instructions for receiving a cession frequency;
one or more instructions for receiving a number of annual contracts expected;
one or more instructions for receiving an expected annual premium growth percentage;
one or more instructions for receiving an expected annual contract growth percentage;
one or more instructions for receiving a percent of the premium ceded at time of contract writing;
one or more instructions for receiving a percent of premium ceded at time of earning;
one or more instructions for receiving an indication as to the earnings curve methodology to be applied; and
one or more instructions for receiving a loss ratio variance from inputs.

61. The software application of claim 59, wherein the one or more instructions for receiving underwriter input assumption information, further comprise at least one of:
one or more instructions for receiving an underwriter investment yield rate per year;
one or more instructions for receiving a starting month to being analysis;
one or more instructions for receiving an indication regarding whether contract sales are to be weighted by month or prorated for an entire year;
one or more instructions for receiving the percentage of administrative fee to be earned as written;
one or more instructions for receiving a standard administrative fee amount for each contract;
one or more instructions for receiving an additional administrative fee amount as a percentage of premium;
one or more instructions for receiving a reinsurance co. loss adjustment expense fee per claim;
one or more instructions for receiving a number of assumed claims frequency per contract;
one or more instructions for receiving a run-off fee per outstanding contract per month;
one or more instructions for receiving a run-off fee threshold;
one or more instructions for receiving an underwriter tax rate;
one or more instructions for receiving a percentage of underwriter investment income that is taxable;
one or more instructions for receiving a cost per contract for an auto road club;
one or more instructions for receiving an underwriter loss adjustment expense fee per claim;
one or more instructions for receiving an underwriter base cost per contract;
one or more instructions for receiving an underwriter processing expense per contract;
one or more instructions for receiving an underwriter marketing and acquisition cost per contract; and
one or more instructions for receiving a cost of agent no chargebacks per contract.

62. The software application of claim 58, wherein the one or more instructions for generating reinsurance analysis information includes one or more instructions for generating an estimated per contract profit for a reinsurance provider.

63. The software application of claim 58, wherein the one or more instructions for generating reinsurance analysis information includes one or more instructions for generating an estimated per contract profit for an underwriter.

64. The software application of claim 58, wherein the one or more instructions for receiving premium and vehicle mix information further comprises one or more instructions for electronically retrieving the premium and vehicle mix information from a warranty product comparison tool.

65. The software application of claim 58, further comprising:
one or more instructions for receiving a user selection to view a reinsurance proforma report;
generating a reinsurance proforma report based upon the received input assumption, premium and vehicle mix information and the generated reinsurance analysis information.

66. The software application of claim 58, further comprising:
one or more instructions for receiving a user selection to view an underwriter proforma report;
one or more instructions for generating an underwriter proforma report based upon the received input assumption, premium and vehicle mix information and the generated reinsurance analysis information.

67. A method for enabling interactive analysis of reinsurance business for extended warranty products, comprising the step of:
receiving a selection of at least one warranty product;
receiving input assumption information;
receiving premium and vehicle mix information for each of the at least one warranty product;
receiving loss ratio information for each of the at least one warranty product;
generating reinsurance analysis information; and
displaying the reinsurance analysis information to a user.

68. The method of claim 67, wherein the step of receiving input assumption information further comprises the steps of:
receiving reinsurance company input assumption information; and
receiving underwriter input assumption information.

69. The method of claim 68, wherein the step of receiving reinsurance company input assumption information, further comprises at least one of the steps of:
receiving a reinsurance co. interest rate per year;
receiving a premium tax rate;
receiving an indication as to who pays a premium tax;
receiving a dividend trust requirement;
receiving the up front amount required to start operations;
receiving an indication regarding tax election status;
receiving a tax exempt filing costs amount;
receiving a stop after month indication;
receiving a ceding fee amount;
receiving a cession frequency;
receiving a number of annual contracts expected;
receiving an expected annual premium growth percentage;
receiving an expected annual contract growth percentage;
receiving a percent of the premium ceded at time of contract writing;
receiving a percent of premium ceded at time of earning;
receiving an indication as to the earnings curve methodology to be applied; and
receiving a loss ratio variance from inputs.

70. The method of claim 68, wherein the step of receiving underwriter input assumption information, further comprises at least one of the steps of:
receiving an underwriter investment yield rate per year;
receiving a starting month to being analysis;
receiving an indication regarding whether contract sales are to be weighted by month or prorated for an entire year;
receiving the percentage of administrative fee to be earned as written;
receiving a standard administrative fee amount for each contract;
receiving an additional administrative fee amount as a percentage of premium;
receiving a reinsurance co. loss adjustment expense fee per claim;
receiving a number of assumed claims frequency per contract;
receiving a run-off fee per outstanding contract per month;
receiving a run-off fee threshold;
receiving an underwriter tax rate;
receiving a percentage of underwriter investment income that is taxable;
receiving a cost per contract for an auto road club;
receiving an underwriter loss adjustment expense fee per claim;
receiving an underwriter base cost per contract;
receiving an underwriter processing expense per contract;
receiving an underwriter marketing and acquisition cost per contract; and
receiving a cost of agent no chargebacks per contract.

71. The method of claim 67, wherein the step of generating reinsurance analysis information includes the step of generating an estimated per contract profit for a reinsurance provider.

72. The method of claim 67, wherein the step of generating reinsurance analysis information includes the step of generating an estimated per contract profit for an underwriter.

73. The method of claim 67, wherein the step of receiving premium and vehicle mix information further comprises the step of electronically retrieving the premium and vehicle mix information from a warranty product comparison tool.

74. The method of claim 67, further comprising the steps of:
receiving a user selection to view a reinsurance proforma report;
generating a reinsurance proforma report based upon the received input assumption, premium and vehicle mix information and the generated reinsurance analysis information.

75. The method of claim 67, further comprising the steps of:
receiving a user selection to view an underwriter proforma report;
generating an underwriter proforma report based upon the received input assumption, premium and vehicle mix information and the generated reinsurance analysis information.

76. A system for enabling interactive analysis of reinsurance business for extended warranty products, comprising:
means for receiving a selection of at least one warranty product;
means for receiving input assumption information;
means for receiving premium and vehicle mix information for each of the at least one warranty product;
means for receiving loss ratio information for each of the at least one warranty product;
means for generating reinsurance analysis information; and
means for displaying the reinsurance analysis information to a user.

77. The system of claim 76, wherein the means for receiving input assumption information further comprise:
means for receiving reinsurance company input assumption information; and
means for receiving underwriter input assumption information.

78. The method of claim 77, wherein the means for receiving reinsurance company input assumption information, further comprise at least one of:
means for receiving a reinsurance co. interest rate per year;
means for receiving a premium tax rate;
means for receiving an indication as to who pays a premium tax;
means for receiving a dividend trust requirement;
means for receiving the up front amount required to start operations;
means for receiving an indication regarding tax election status;
means for receiving a tax exempt filing costs amount;
means for receiving a stop after month indication;
means for receiving a ceding fee amount;
means for receiving a cession frequency;
means for receiving a number of annual contracts expected;
means for receiving an expected annual premium growth percentage;
means for receiving an expected annual contract growth percentage;
means for receiving a percent of the premium ceded at time of contract writing;
means for receiving a percent of premium ceded at time of earning;
means for receiving an indication as to the earnings curve methodology to be applied; and
means for receiving a loss ratio variance from inputs.

79. The system of claim 77, wherein the means for receiving underwriter input assumption information, further comprise at least one of:
means for receiving an underwriter investment yield rate per year;
means for receiving a starting month to being analysis;
means for receiving an indication regarding whether contract sales are to be weighted by month or prorated for an entire year;
means for receiving the percentage of administrative fee to be earned as written;
means for receiving a standard administrative fee amount for each contract;
means for receiving an additional administrative fee amount as a percentage of premium;
means for receiving a reinsurance co. loss adjustment expense fee per claim;
means for receiving a number of assumed claims frequency per contract;
means for receiving a run-off fee per outstanding contract per month;
means for receiving a run-off fee threshold;
means for receiving an underwriter tax rate;
means for receiving a percentage of underwriter investment income that is taxable;
means for receiving a cost per contract for an auto road club;
means for receiving an underwriter loss adjustment expense fee per claim;
means for receiving an underwriter base cost per contract;
means for receiving an underwriter processing expense per contract;
means for receiving an underwriter marketing and acquisition cost per contract; and
means for receiving a cost of agent no chargebacks per contract.

80. The system of claim 76, wherein the means for generating reinsurance analysis information include means for generating an estimated per contract profit for a reinsurance provider.

81. The system of claim 76, wherein the means for generating reinsurance analysis information include means for generating an estimated per contract profit for an underwriter.

82. The system of claim 76, wherein the means for receiving premium and vehicle mix information further comprise means for electronically retrieving the premium and vehicle mix information from a warranty product comparison tool.

83. The system of claim 76, further comprising:
means for receiving a user selection to view a reinsurance proforma report;
means for generating a reinsurance proforma report based upon the received input assumption, premium and vehicle mix information and the generated reinsurance analysis information.

84. The system of claim 76, further comprising:
means for receiving a user selection to view an underwriter proforma report;
means for generating an underwriter proforma report based upon the received input assumption, premium and vehicle mix information and the generated reinsurance analysis information.
